(19) United States
(12) Patent Application Publication
(10) Pub. No.: US 2026/0092633 A1
(43) Pub. Date: Apr. 2, 2026

(54) SHOCK ABSORBER

(71) Applicant: Hitachi Astemo, Ltd., Ibaraki (JP)

(72) Inventors: Shivanand SANKARAN, Hitachinaka-shi (JP); Sean LUNDBERG, Hitachinaka-shi (JP); Jordan TRUITT, Hitachinaka-shi (JP)

(21) Appl. No.: 19/110,475

(22) PCT Filed: Sep. 15, 2023
(86) PCT No.: PCT/US2023/032854

§ 371 Date: Mar. 11, 2025

Related U.S. Application Data
(63) Continuation of application No. 17/954,389, filed on Sep. 28, 2022, now Pat. No. 12,372,133.

(51) Int. Cl. F16F 9/348; B60G 13/08; B60G 15/06; F16F 9/22; F16F 9/49

(52) U.S. Cl. CPC F16F 9/348; B60G 13/08; B60G 15/062; F16F 9/22; F16F 9/49; B60G 2202/23; B60G 2202/24; B60G 2202/31

(57) ABSTRACT

This shock absorber includes a first valve assembly connected to one end of a tube in an axial direction, a piston assembly dividing an inner chamber of the tube into a first chamber and a second chamber, a piston rod extending from the tube through the first chamber with the piston assembly connected to an intermediate position in the axial direction, a cup provided in the second chamber, and a second valve assembly disposed in the second chamber to be connected to the piston rod and configured to enter and exit from the cup. The cup includes a sleeve disposed in the second chamber with a gap between itself and the tube in a radial direction, and a base adapter fixed to the sleeve by press fitting and provided between the sleeve and the first valve assembly.

### TECHNICAL FIELD

The present disclosure relates to a shock absorber.

Priority is claimed on U.S. patent application, Publication Ser. No. 17/954,389 filed in the United States on Sep. 28, 2022, the content of which is incorporated herein by reference.

### BACKGROUND ART

There are shock absorbers in which a damping force increases when a rod reaches a predetermined range on a limit side during a compression stroke in which the rod is pushed into a cylinder.

### PATENT DOCUMENT

### Patent Document 1

U.S. Pat. No. 9,605,726

### SUMMARY OF INVENTION

### Technical Problem

Incidentally, there has been a demand to suppress an increase in cost in shock absorbers.

Accordingly, an objective of the present disclosure is to provide a shock absorber in which an increase in cost can be suppressed.

### Solution to Problem

In order to achieve the above-described objective, one aspect of a shock absorber of the present disclosure includes a tube having an inner chamber inside, a first valve assembly connected to one end of the tube in an axial direction, a piston assembly dividing the inner chamber into a first chamber and a second chamber, a piston rod extending from the tube through the first chamber with the piston assembly connected to an intermediate position thereof in the axial direction, a cup provided in the second chamber, and a second valve assembly disposed in the second chamber to be connected to the piston rod and configured to enter and exit from the cup. The cup includes a sleeve disposed in the second chamber with a gap between itself and the tube in a radial direction, and a base adapter fixed to the sleeve by press fitting and provided between the sleeve and the first valve assembly.

Another aspect of the shock absorber of the present disclosure includes a first tube, a piston rod disposed in the first tube, a primary piston and a first valve disposed on the piston rod, a secondary piston and a second valve disposed on the piston rod, and a second tube configured so as to be able to accommodate the secondary piston, in which the secondary piston is constituted by combining a first piston member and a second piston member, the first piston member has a first communication passage inside or on an inner circumferential surface side and includes a seat, on which the second valve is placed, formed on one end surface facing the primary piston, the second piston member includes a second communication passage formed to communicate with the first communication passage and the inside of the second tube, and a ring accommodating groove accommodating a ring is provided on an outer circumferential side of at least one of the first piston member and the second piston member, and on a contact surface side at which the first piston member and the second piston member are in contact with each other.

### Advantageous Effects of Invention

According to each of the above-described aspects of the present disclosure, it is possible to suppress an increase in cost.

### BRIEF DESCRIPTION OF DRAWINGS

FIG. 1 is a view illustrating a shock absorber of a first embodiment according to the present disclosure, and is a cross-sectional view seen in a cross section including a central axis line CL.

FIG. 2 is a view illustrating a main part of the same shock absorber and is a partially enlarged cross-sectional view of FIG. 1.

FIG. 3 is a view illustrating a main part of the same shock absorber and is a partially enlarged cross-sectional view of FIG. 2.

FIG. 4 is a view illustrating a shock absorber of a second embodiment according to the present disclosure, and is a partially enlarged cross-sectional view seen in a cross section including a central axis line CL.

FIG. 5 is a view illustrating a shock absorber of a third embodiment according to the present disclosure, and is a cross-sectional view seen in a cross section including a central axis line CL.

FIG. 6 is a view illustrating a main part of the same shock absorber and is a partially enlarged cross-sectional view of FIG. 5.

### DESCRIPTION OF EMBODIMENTS

### First Embodiment

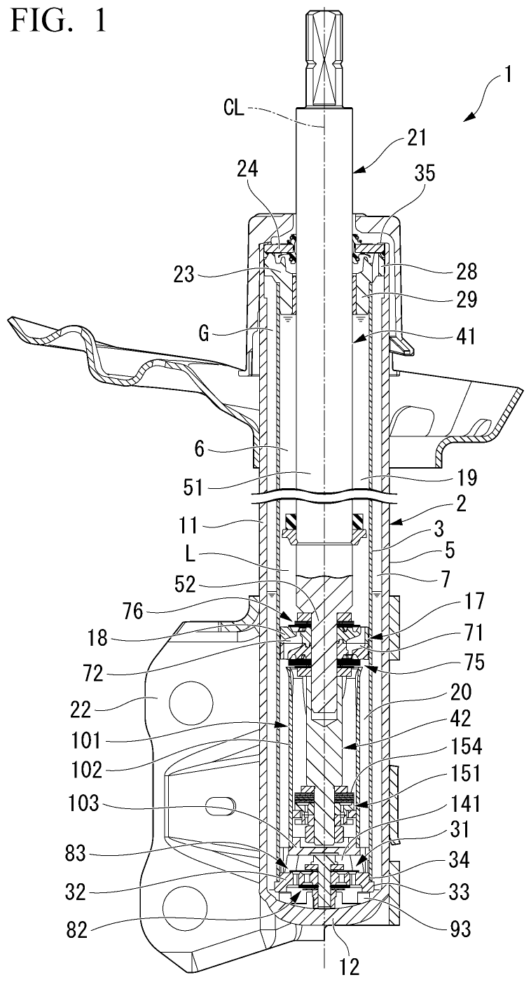

A shock absorber of a first embodiment according to the present disclosure will be described with reference to FIGS. 1 to 3. Further, in the following description, for convenience of explanation, an upper side in the drawings will be referred to as “upper” and a lower side in the drawings will be referred to as “lower.” Also, reference sign CL denoted in each figure indicates a central axis of the shock absorber.

As shown in FIG. 1, a shock absorber 1 of the first embodiment is a dual-tube type hydraulic shock absorber. The shock absorber 1 is used in suspension devices of vehicles, specifically, automobiles. The shock absorber 1 includes a cylinder 2. The cylinder 2 includes a tube 3 (first tube) and a shell 5. The tube 3 has a cylindrical shape. The shell 5 has a bottomed cylindrical shape. The shell 5 has an inner diameter larger than an outer diameter of the tube 3. The tube 3 is disposed on a radially inner side of the shell 5. A central axis of the tube 3 and a central axis of the shell 5 coincide with each other. The tube 3 has an inner chamber 6 inside. A reservoir chamber 7 is provided between the tube 3 and the shell 5.

The shell 5 includes a barrel part 11 and a bottom part 12. The barrel part 11 and the bottom part 12 are formed seamlessly and integrally. The barrel part 11 has a cylindrical shape. The bottom part 12 closes a lower portion of the barrel part 11.

The shock absorber 1 includes a piston assembly 17. The piston assembly 17 is disposed in the tube 3 of the cylinder 2. The piston assembly 17 includes a piston 18 (primary piston). In the piston assembly 17, the piston 18 is fitted in the tube 3 to be slidable. The piston 18 divides the inner chamber 6 in the tube 3 into two chambers, a first chamber 19 on one side and a second chamber 20 on the other side. The first chamber 19 is on a side opposite to the bottom part 12 with respect to the piston 18 in an axial direction of the tube 3. The second chamber 20 is on the bottom part 12 side with respect to the piston 18 in the axial direction of the tube 3. In the cylinder 2, an oil fluid L as a working fluid is sealed in the inner chamber 6 inside the tube 3. In the cylinder 2, the oil fluid L and a gas G are sealed as working fluids in the reservoir chamber 7 between the tube 3 and the shell 5.

The shock absorber 1 includes a piston rod 21. One side of the piston rod 21 in the axial direction is disposed in the tube 3 of the cylinder 2. This one side of the piston rod 21 is connected to the piston assembly 17. The other side of the piston rod 21 in the axial direction extends from the cylinder 2 to the outside of the cylinder 2. The piston rod 21 extends from the tube 3 and the shell 5, that is, the cylinder 2, through the first chamber 19 with the piston assembly 17 attached thereto.

In the shock absorber 1, a portion of the piston rod 21 extending from the cylinder 2 is disposed at an upper portion to be connected to a vehicle body of a vehicle. At the same time, in the shock absorber 1, a mounting bracket 22 fixed to the barrel part 11 of the shell 5 is disposed at a lower portion to be connected to a wheel side of the vehicle.

The piston 18 is fixed to the piston rod 21. Therefore, the piston 18 and the piston rod 21 move together. In the shock absorber 1, a stroke in which the piston rod 21 moves in a direction to increase a protrusion amount from the cylinder 2 is an extension stroke in which the entire length increases. In the shock absorber 1, a stroke in which the piston rod 21 moves in a direction to decrease the protrusion amount from the cylinder 2 is a compression stroke in which the entire length decreases. In the shock absorber 1, the piston 18 moves to the first chamber 19 side during the extension stroke. In the shock absorber 1, the piston 18 moves to the second chamber 20 side during the compression stroke.

A rod guide 23 is fitted to an upper end opening side of the tube 3 and an upper end opening side of the shell 5. A seal member 24 is fitted to the shell 5 on an upper side of the rod guide 23. Both the rod guide 23 and the seal member 24 are annular. The piston rod 21 is inserted through a radially inner side of the rod guide 23 and the seal member 24. The piston rod 21 slides with respect to the rod guide 23 and the seal member 24 in the axial direction. The piston rod 21 extends from the inside of the cylinder 2 to the outside of the cylinder 2 from the seal member 24.

The rod guide 23 restricts movement of the piston rod 21 in the radial direction with respect to the tube 3 and the shell 5 of the cylinder 2. The piston rod 21 is fitted in the rod guide 23 and the piston 18 is fitted in the tube 3. Thereby, a central axis of the piston rod 21 and a central axis of the tube 3 coincide with each other. The rod guide 23 supports the piston rod 21 to be movable in the axial direction of the piston rod 21. The seal member 24 has an outer circumferential portion in close contact with the shell 5. The seal member 24 has an inner circumferential portion in close contact with an outer circumferential portion of the piston rod 21. The piston rod 21 moves in the axial direction of the seal member 24 with respect to the seal member 24. The seal member 24 suppresses the oil fluid L in the tube 3 and the high-pressure gas G and the oil fluid L in the reservoir chamber 7 leaking out to the outside.

The rod guide 23 includes a large diameter part 28 and a small diameter part 29. The large diameter part 28 has an outer diameter larger than an outer diameter of the small diameter part 29. In the rod guide 23, the small diameter part 29 is provided on a lower side of the large diameter part 28. The rod guide 23 is fitted to an inner circumferential portion of an upper end of the tube 3 at the small diameter part 29 on the lower side. At that time, an upper end portion of the tube 3 is in contact with the large diameter part 28 in the axial direction of the tube 3. The rod guide 23 is fitted to an upper inner circumferential portion of the shell 5 at the large diameter part 28 on the upper side.

A first valve assembly 31 is placed on the bottom part 12 of the shell 5. The first valve assembly 31 includes a seat member 32. The seat member 32 is placed in contact with an upper surface of the bottom part 12 of the shell 5. The seat member 32 is positioned in the radial direction with respect to the shell 5. The seat member 32 includes a large diameter part 33 and a small diameter part 34. The large diameter part 33 has an outer diameter larger than an outer diameter of the small diameter part 34. In the seat member 32, the large diameter part 33 is provided on a lower side of the small diameter part 34. The seat member 32 is fitted to an inner circumferential portion of a lower end of the tube 3 at the small diameter part 34 on an upper side. At that time, the lower end portion of the tube 3 comes in contact with the large diameter part 33 in the axial direction of the tube 3. Thereby, the first valve assembly 31 is connected to one end of the tube 3 in the axial direction.

A swaged part 35 is provided at an upper end portion of the shell 5. The swaged part 35 is formed by swaging the upper end portion of the shell 5 inward in the radial direction of the shell 5. The seal member 24 is fixed to the cylinder 2 by being sandwiched between the swaged part 35 and the rod guide 23. When the swaged part 35 is formed, the seal member 24 is pressed against the rod guide 23 in the axial direction of the shell 5 while the bottom part 12 of the shell 5 is placed on a table. Then, the seal member 24, the rod guide 23, the tube 3, and the seat member 32 are in contact with each other without a gap in the axial direction. Thereby, an axial force is generated in the seal member 24, the rod guide 23, the tube 3, and the seat member 32. In this state, the swaged part 35 is formed. Therefore, after the swaged part 35 is formed, an axial force is generated in the seal member 24, the rod guide 23, the tube 3, and the seat member 32.

The piston rod 21 includes a rod main body 41 and an extender 42.

The rod main body 41 includes a main shaft part 51 and a mounting shaft part 52. Both the main shaft part 51 and the mounting shaft part 52 have a rod shape. The mounting shaft part 52 has an outer diameter smaller than has an outer diameter of the main shaft part 51. The mounting shaft part 52 extends from one end of the main shaft part 51 in the axial direction. A central axis of the mounting shaft part 52 coincides with a central axis of the main shaft part 51. The mounting shaft part 52 is disposed in the tube 3 in its entirety. The main shaft part 51 of the rod main body 41 of the piston rod 21 slides with respect to the rod guide 23 and the seal member 24 in the axial direction of them.

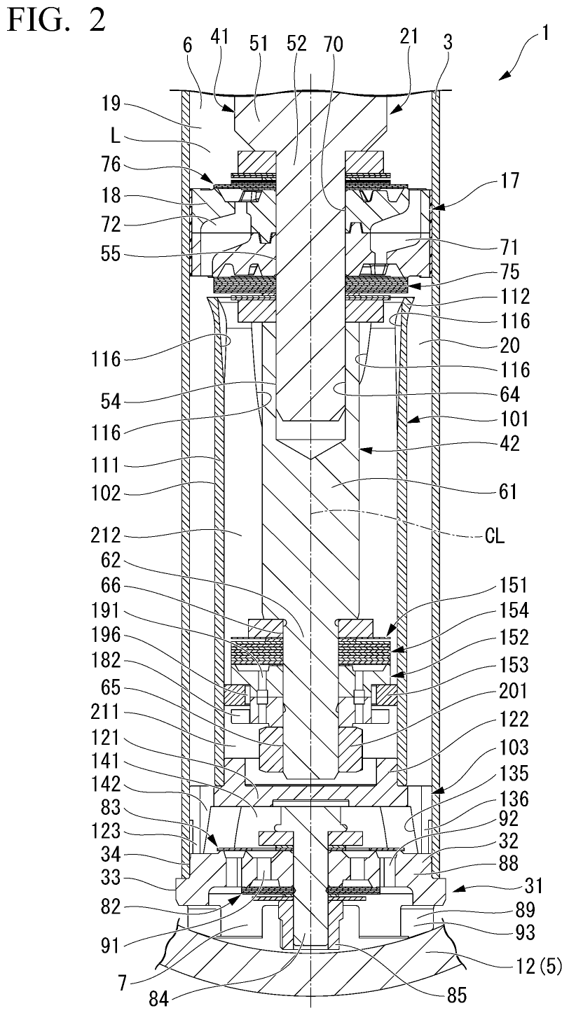

As shown in FIG. 2, an end portion of the mounting shaft part 52 on a side opposite to the main shaft part 51 in the axial direction of the mounting shaft part 52 is a screw shaft part 54. The screw shaft part 54 has a male screw formed on an outer circumferential portion. A portion of the mounting shaft part 52 between the main shaft part 51 and the screw shaft part 54 in the axial direction of the mounting shaft part 52 is a fitting shaft part 55. An outer circumferential surface of the fitting shaft part 55 is a cylindrical surface.

The extender 42 includes a main shaft part 61 and a mounting shaft part 62. Both the main shaft part 61 and the mounting shaft part 62 have a rod shape. The mounting shaft part 62 has an outer diameter smaller than an outer diameter of the main shaft part 61. The mounting shaft part 62 extends from one end of the main shaft part 61 in the axial direction. A central axis of the mounting shaft part 62 coincides with a central axis of the main shaft part 61.

A screw hole 64 is formed in the main shaft part 61 at an end portion of the main shaft part 61 on a side opposite to the mounting shaft part 62 in the axial direction. The screw hole 64 is formed at a center position of the main shaft part 61 in the radial direction. The screw hole 64 extends in the axial direction of the main shaft part 61. The screw hole 64 opens upward.

An end portion of the mounting shaft part 62 on a side opposite to the main shaft part 61 in the axial direction of the mounting shaft part 62 is a screw shaft part 65. The screw shaft part 65 has a male screw formed on an outer circumferential portion. A portion of the mounting shaft part 62 between the main shaft part 61 and the screw shaft part 65 in the axial direction of the mounting shaft part 62 is a fitting shaft part 66. An outer circumferential surface of the fitting shaft part 66 is a cylindrical surface.

In the rod main body 41, the screw shaft part 54 thereof is screwed into the screw hole 64 of the extender 42. Thereby, the rod main body 41 and the extender 42 are connected with their central axes coincided with each other. Thereby, the piston rod 21 is formed. The extender 42 is disposed in the tube 3 in its entirety.

The piston 18 is attached to the piston rod 21 at the mounting shaft part 52 of the rod main body 41. Then, the piston 18 is disposed between the main shaft part 51 of the rod main body 41 and the extender 42. The piston 18 is fitted in the fitting shaft part 55 of the mounting shaft part 52.

A through hole 70 is formed at a center of the piston 18 in the radial direction. The through hole 70 penetrates the piston 18 in the axial direction of the piston 18. The fitting shaft part 55 of the rod main body 41 is fitted into the through hole 70 of the piston 18. A first passage 71 and a second passage 72 are formed in the piston 18 on a side outward from the through hole 70 in the radial direction of the piston 18. The first passage 71 and the second passage 72 penetrate the piston 18 in the axial direction of the piston 18. A plurality of first passages 71 and a plurality of second passages 72 are formed in the piston 18. The first passages 71 and the second passages 72 are alternately disposed in the circumferential direction of the piston 18. Both the first passages 71 and the second passages 72 allow communication between the first chamber 19 and the second chamber 20.

The piston assembly 17 includes a first damping valve 75 (first valve) and a second damping valve 76 (second valve).

The first damping valve 75 is a disc valve constituted by laminating a plurality of annular discs. The fitting shaft part 55 of the rod main body 41 is fitted to a radially inner side of the first damping valve 75. The first damping valve 75 is disposed between the piston 18 and the extender 42. The first damping valve 75 opens the first passage 71 when a portion on the outer circumferential side is separated from the piston 18. Thereby, the first damping valve 75 allows the oil fluid L to flow from the first chamber 19 to the second chamber 20 through the first passage 71. At that time, the first damping valve 75 suppresses a flow of the oil fluid L to generate a damping force. The first damping valve 75 is provided in the first passage 71 to generate a damping force by suppressing the flow of the oil fluid L that occurs in the first passage 71 during the extension stroke. The first damping valve 75 closes the first passage 71 when the portion on the outer circumferential side comes in contact with the piston 18. A fixed orifice (not shown) is provided at a portion between the first damping valve 75 and the piston 18. The fixed orifice allows the oil fluid L to flow from the first chamber 19 to the second chamber 20 through the first passage 71 even if the portion on the outer circumferential side of the first damping valve 75 comes in contact with the piston 18.

The second damping valve 76 is a disc valve constituted by laminating a plurality of annular discs. The fitting shaft part 55 is fitted to a radially inner side of the second damping valve 76. The second damping valve 76 is disposed between the main shaft part 51 of the rod main body 41 and the piston 18. The second damping valve 76 opens the second passage 72 when a portion on the outer circumferential side is separated from the piston 18. Thereby, the second damping valve 76 allows the oil fluid L to flow from the second chamber 20 to the first chamber 19 via the second passage 72. At that time, the second damping valve 76 generates a damping force by suppressing a flow of the oil fluid L. The second damping valve 76 is provided in the second passage 72 to generate a damping force by suppressing the flow of the oil fluid L that occurs in the second passage 72 during the compression stroke. The second damping valve 76 closes the second passage 72 when the portion on the outer circumferential side comes in contact with the piston 18. A fixed orifice (not shown) is provided at a portion between the second damping valve 76 and the piston 18. The fixed orifice allows the oil fluid L to flow from the second chamber 20 to the first chamber 19 through the second passage 72 even if the portion on the outer circumferential side of the second damping valve 76 comes in contact with the piston 18.

The piston assembly 17 including the piston 18, the first damping valve 75, and the second damping valve 76 is attached to the mounting shaft part 52 of the rod main body 41 by the extender 42. Therefore, the piston assembly 17 is disposed between the main shaft part 51 of the rod main body 41 and the extender 42. The piston assembly 17 is connected to the piston rod 21 at an intermediate position in the axial direction. The piston 18, the first damping valve 75, and the second damping valve 76 are disposed in the piston rod 21.

The first valve assembly 31 includes a disc valve 82, a disc valve 83, a bolt 84, and a nut 85 in addition to the seat member 32 described above. The disc valve 82 is provided on a lower side of the seat member 32. The disc valve 83 is provided on an upper side of the seat member 32. The bolt 84 is inserted into the disc valve 83, the seat member 32 and the disc valve 82 from above. In this state, the nut 85 is screwed onto a lower portion of the bolt 84. The bolt 84 and nut 85 thereby attach the disc valve 82 and the disc valve 83 to the seat member 32.

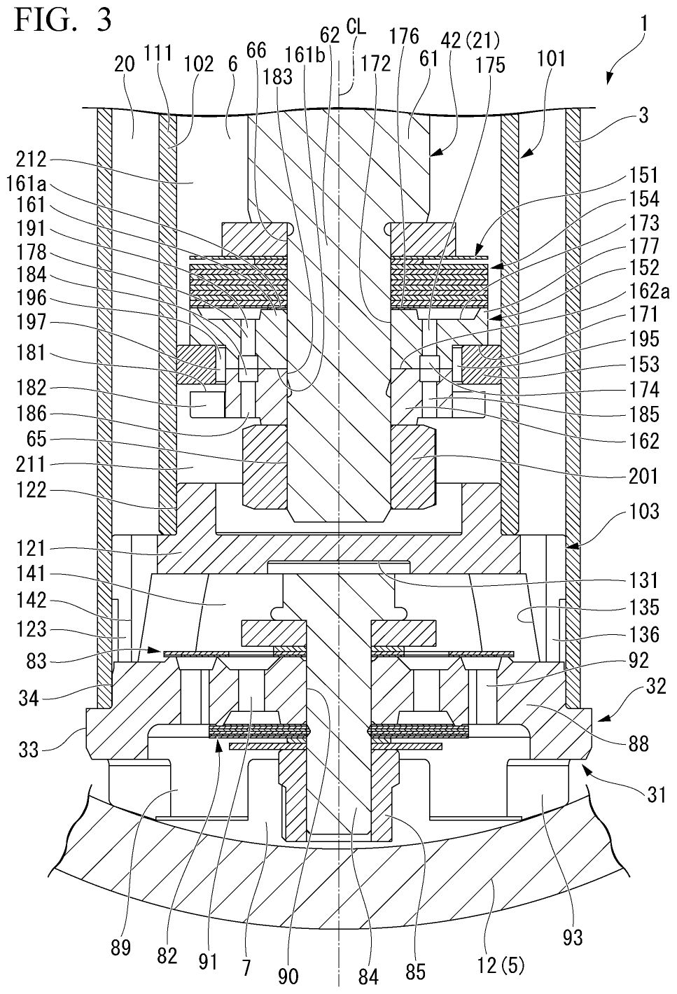

The seat member 32 has an annular shape. The seat member 32 includes a base part 88 and a protruding part 89. The base part 88 has a disc shape. As shown in FIG. 3, the base part 88 has a through hole 90 formed at a center in the radial direction. The through hole 90 penetrates the base part 88 in the axial direction of the seat member 32. The bolt 84 is inserted through the through hole 90 of the seat member 32. A passage hole 91 and a passage hole 92 are formed in the seat member 32 on a side outward from the through hole 90 in the radial direction of the seat member 32. The passage hole 91 and the passage hole 92 penetrate the base part 88 in the axial direction of the seat member 32. The passage hole 92 is on a side outward from the passage hole 91 in the radial direction of the seat member 32. A plurality of passage hole 91 and a plurality of passage holes 92 are formed in the seat member 32.

The protruding part 89 protrudes downward from an outer circumferential portion of the base part 88. The protruding part 89 is disposed on a side outward from the passage holes 92 in the radial direction of the base part 88. The protruding part 89 of the seat member 32 is in contact with the bottom part 12 of the shell 5. A passage groove 93 penetrating the protruding part 89 in the radial direction of the seat member 32 is formed in the protruding part 89. A plurality of passage grooves 93 are provided in the seat member 32 at regular intervals in the circumferential direction of the seat member 32. Thereby, a space between the seat member 32 and the bottom part 12 of the shell 5 communicates with a portion between the barrel part 11 of the shell 5 and the tube 3 shown in FIG. 1. Therefore, the space between the seat member 32 and the bottom part 12 of the shell 5 also forms the reservoir chamber 7.

As shown in FIG. 2, the shock absorber 1 includes a cup 101. The cup 101 is provided in the second chamber 20. The cup 101 includes a sleeve 102 (second tube) and a base adapter 103.

The sleeve 102 has a cylindrical shape. The sleeve 102 has an outer diameter smaller than an inner diameter of the tube 3. The sleeve 102 is disposed on a radially inner side of the tube 3. A central axis of the sleeve 102 coincides with a central axis of the tube 3. The sleeve 102 is disposed in the second chamber 20 with a gap between itself and the tube 3 in the radial direction.

The sleeve 102 includes a main body part 111 and an enlarged diameter part 112. The main body part 111 has a cylindrical shape and is provided from an intermediate portion to a lower end portion in the axial direction of the sleeve 102. The enlarged diameter part 112 is provided at an upper end portion of the sleeve 102. An inner diameter of the enlarged diameter part 112 increases toward an upper end. An outer diameter of the enlarged diameter part 112 increases toward the upper end. The enlarged diameter part 112 increases in diameter in a direction away from the main body part 111 in the axial direction of the sleeve 102.

The sleeve 102 includes a groove 116 extending in the axial direction of the sleeve 102 at an inner circumferential portion on one end side thereof in the axial direction. The groove 116 is provided on the inner circumferential portion of the upper end side of the sleeve 102. The groove 116 is recessed outward in the radial direction of the sleeve 102 from an inner circumferential surface of the sleeve 102. The groove 116 extends from the enlarged diameter part 112 to an upper portion of the main body part 111. A plurality of grooves 116 are provided in the sleeve 102 at regular intervals in the circumferential direction of the sleeve 102. The plurality of grooves 116 have different lengths from the upper end of the sleeve 102. In other words, the plurality of grooves 116 have different lengths in the axial direction of the sleeve 102.

The base adapter 103 has an annular shape. The base adapter 103 includes a main plate part 121, a press-fitting part 122, and a leg part 123.

The main plate part 121 has a disc shape. As shown in FIG. 3, a recessed part 131 recessed upward from a lower surface of the main plate part 121 is formed in the main plate part 121 at a central portion in the radial direction on one side in the axial direction.

The press-fitting part 122 is provided at one end of the base adapter 103 in the axial direction. The press-fitting part 122 protrudes upward from an upper surface of the main plate part 121. The press-fitting part 122 has a cylindrical shape. The press-fitting part 122 has an outer diameter smaller than an outer diameter of the main plate part 121. The press-fitting part 122 of the base adapter 103 is press-fitted into a lower end portion of the sleeve 102. At that time, the upper surface of the main plate part 121 comes in contact with the lower end portion of the sleeve 102. Thereby, the base adapter 103 is fixed to the sleeve 102. In the way, the base adapter 103 is fixed to the sleeve 102 by press fitting.

The leg part 123 is provided at an end portion of the base adapter 103 on a side opposite to the press-fitting part 122 in the axial direction. The leg part 123 protrudes downward from an outer circumferential portion of the main plate part 121. The leg part 123 has a cylindrical shape. The leg part 123 is disposed on a side outward from the recessed part 131 in the radial direction of the main plate part 121. An inner circumferential portion 135 on an inner side of the leg part 123 in the radial direction becomes larger in diameter with distance away from the main plate part 121 in the axial direction of the base adapter 103. In other words, the inner circumferential portion 135 of the leg part 123 becomes larger in diameter with distance away from the main plate part 121 in the axial direction.

A communication groove 136 penetrating the main plate part 121 and the leg part 123 in the axial direction of the base adapter 103 is formed in the outer circumferential portion of the main plate part 121 and the leg part 123. The communication groove 136 opens outward in the radial direction of the base adapter 103. The communication groove 136 is formed on a side of the main plate part 121 radially outward from the sleeve 102. The communication groove 136 penetrates the leg part 123 in the radial direction of the base adapter 103. Therefore, the communication groove 136 opens to the upper surface of the main plate part 121, an outer circumferential surface of the main plate part 121, an outer circumferential surface of the leg part 123, a lower surface of the leg part 123, and an inner circumferential surface of the leg part 123. A plurality of communication grooves 136 are provided in the base adapter 103 at regular intervals in the circumferential direction of the base adapter 103.

The cup 101 including the base adapter 103 and the sleeve 102 fixed to the base adapter 103 is fixed by press-fitting the main plate part 121 of the base adapter 103 into the tube 3. At that time, the cup 101 is placed by bringing a lower end portion of the leg part 123 of the base adapter 103 into contact with an upper surface of the outer circumferential portion of the base part 88 of the seat member 32. At that time, the base adapter 103 hitting the bolt 84 of the first valve assembly 31 is avoided by the recessed part 131. At that time, the leg part 123 of the base adapter 103 surrounds the disc valve 83 of the first valve assembly 31 from an outer side in the radial direction. In other words, the leg part 123 is disposed to be spaced apart from the disc valve 83 on a side outward in the radial direction of the disc valve 83. The base adapter 103 placed on the first valve assembly 31 is provided between the sleeve 102 and the first valve assembly 31.

As described above, the press-fitting part 122 that is press-fitted into the sleeve 102 is provided at one end of the base adapter 103 in the axial direction. The leg part 123 placed on the first valve assembly 31 is provided at the other end of the base adapter 103 in the axial direction. The inner circumferential portion 135 of the leg part 123 increases in diameter toward the first valve assembly 31 in the axial direction of the base adapter 103.

A third chamber 141 is provided between the first valve assembly 31 and the base adapter 103. The third chamber 141 communicates with a portion of the second chamber 20 between the tube 3 and the sleeve 102 via a communication passage 142 in the communication groove 136 of the base adapter 103. In other words, the communication passage 142 that allows communication between the second chamber 20 and the third chamber 141 is provided in the leg part 123 of the base adapter 103.

In the first valve assembly 31, the plurality of passage holes 91 allow the oil fluid L to flow between the third chamber 141 and the reservoir chamber 7. The plurality of passage holes 92 allow the oil fluid L to flow between the reservoir chamber 7 and the third chamber 141.

The disc valve 82 on the reservoir chamber 7 side allows the oil fluid L to flow from the third chamber 141 to the reservoir chamber 7 through the passage holes 91. On the other hand, the disc valve 82 restricts a flow of the oil fluid L from the reservoir chamber 7 to the third chamber 141 through the passage holes 91. The disc valve 82 opens during the compression stroke of the shock absorber 1 to allow the oil fluid L to flow from the second chamber 20 and the third chamber 141 to the reservoir chamber 7 and generate a damping force.

The disc valve 83 on the third chamber 141 side allows a flow of the oil fluid L from the reservoir chamber 7 to the third chamber 141 through the passage holes 92. On the other hand, the disc valve 83 restricts a flow of the oil fluid L from the third chamber 141 to the reservoir chamber 7 through the passage holes 92. The disc valve 83 allows constant communication between the third chamber 141 and the passage holes 91. The disc valve 83 opens during the extension stroke of the shock absorber 1 to allow the oil fluid L to flow from the reservoir chamber 7 to the third chamber 141 and the second chamber and generate a damping force. Further, the disc valve 83 may be used as a suction valve that allows the oil fluid L to flow from the reservoir chamber 7 to the third chamber 141 and the second chamber substantially without generating a damping force.

As shown in FIG. 2, the sleeve 102 of the cup 101 opens upward. The shock absorber 1 includes a second valve assembly 151. The second valve assembly 151 is disposed in the second chamber 20 to be connected to the piston rod 21. The second valve assembly 151 is attached to the mounting shaft part 62 of the extender 42. The second valve assembly 151 enters from above and exits upward with respect to the sleeve 102 of the cup 101 via an opening at the upper end of the sleeve 102.

The second valve assembly 151 includes a valve base 152 (secondary piston), a fitting member 153 (ring), and a third damping valve 154 (second valve).

As shown in FIG. 3, the valve base 152 includes a first base member 161 (first piston member) and a second base member 162 (second piston member). The valve base 152 is constituted by combining the first base member 161 and the second base member 162. The first base member 161 constitutes an upper portion of the valve base 152. The second base member 162 constitutes a lower portion of the valve base 152.

The first base member 161 has an annular shape. A notch part 171 is formed in the first base member 161 at an outer circumferential portion on a lower side. The notch part 171 is formed over the entire circumference of the first base member 161. The notch part 171 has an annular shape.

The first base member 161 has a through hole 172 formed at a center thereof in the radial direction. The through hole 172 penetrates the first base member 161 in the axial direction of the first base member 161. The fitting shaft part 66 of the extender 42 is fitted in the through hole 172 of the first base member 161. A passage groove 173 is provided in the first base member 161 on a side outward from the through hole 172 in the radial direction of the first base member 161. A passage groove 174 and a passage hole 175 are provided in the first base member 161 between the through hole 172 and the notch part 171 in the radial direction of the first base member 161.

The passage groove 173 is formed at an upper end portion of the first base member 161. The passage groove 173 is recessed downward from an upper end surface 161a (one end surface) of the first base member 161. The passage groove 173 has an annular shape that surrounds the through hole 172 from an outer side in the radial direction. The passage groove 173 opens upward.

At the upper end portion of the first base member 161, a portion on an inner side of the passage groove 173 in the radial direction of the first base member 161 serves as an annular inner seat 176, and a portion on an outer side of the passage groove 173 serves as an annular valve seat 177 (seat). The inner seat 176 and the valve seat 177 are formed on the first base member 161 on an upper end surface 161a which is one end surface facing the piston 18.

The passage groove 174 is formed at a lower end portion of the first base member 161. The passage groove 173 is recessed upward from a lower end surface 161b (contact surface) of the first base member 161. The passage groove 174 has an annular shape that surrounds the through hole 172 from an outer side in the radial direction. The passage groove 174 opens downward.

The passage hole 175 is formed at an intermediate portion of the first base member 161 in the axial direction. An upper end of the passage hole 175 opens at a bottom position of the passage groove 173 and a lower end thereof opens at a bottom position of the passage groove 174. A plurality of passage holes 175 are formed in the first base member 161 at intervals in the circumferential direction of the first base member 161.

In the first base member 161, a passage in the passage groove 173, passages in the plurality of passage holes 175, and a passage in the passage groove 174 constitute a communication passage 178 (first communication passage) that penetrates the first base member 161 in the axial direction. The first base member 161 has the communication passage 178 inside or on an inner circumferential surface side, not on a surface on an outer circumferential side. Specifically, the first base member 161 has the communication passage 178 inside. The first base member 161 may have the communication passage 178 between itself and the inner circumferential surface side, that is, the fitting shaft part 66 of the extender 42.

The second base member 162 has an annular shape. The second base member 162 has a notch part 181 formed at an outer circumferential portion on an upper side. The notch part 181 is formed over the entire circumference of the second base member 162. The notch part 181 has an annular shape.

The second base member 162 includes a groove part 182 formed at an outer circumferential portion on a lower side. The groove part 182 is recessed inward in the radial direction of the second base member 162 from an outer circumferential surface of the second base member 162. The groove part 182 opens outward in the radial direction of the second base member 162. The groove part 182 opens to the notch part 181. The groove part 182 opens downward. A plurality of groove parts 182 are formed in the second base member 162 at intervals in the circumferential direction of the second base member 162.

The second base member 162 has a through hole 183 formed at a center in the radial direction. The through hole 183 penetrates the second base member 162 in the axial direction of the second base member 162. The fitting shaft part 66 of the extender 42 is fitted in the through hole 183 of the second base member 162. A passage groove 184 is provided in the second base member 162 on a side outward from the through hole 183 in the radial direction of the second base member 162. A passage hole 185 is provided in the second base member 162 between the through hole 183 and the notch part 181 in the radial direction of the second base member 162.

The passage groove 184 is formed at an upper end portion of the second base member 162. The passage groove 184 is recessed downward from an upper end surface 162a (contact surface) of the second base member 162. The passage groove 184 has an annular shape that surrounds the through hole 183 from an outer side in the radial direction. The passage groove 184 opens upward.

The passage hole 185 is formed from a middle to a lower end portion in the axial direction of the second base member 162. An upper end of the passage hole 185 opens at a bottom position of the passage groove 184. A plurality of passage holes 185 are formed in the second base member 162 at intervals in the circumferential direction of the second base member 162.

In the second base member 162, a passage in the passage groove 184 and passages in the plurality of passage holes 185 constitute a communication passage 186 (second communication passage) penetrating the second base member 162 in the axial direction. The second base member 162 has the communication passage 186 inside or on an inner circumferential surface side, not on a surface on an outer circumferential side. Specifically, the second base member 162 has the communication passage 186 inside. The second base member 162 may have the communication passage 186 between itself and the inner circumferential surface side, that is, the fitting shaft part 66 of the extender 42.

In a state in which the valve base 152 is fitted to the fitting shaft part 66 of the extender 42, a lower end surface 161b of the first base member 161 is in contact with an upper end surface 162a of the second base member 162. Then, the passage groove 173, the passage holes 175, and the passage groove 174 of the first base member 161 communicate with the passage groove 184 and the passage holes 185 of the second base member 162. These passage grooves 173, 174, and 184 and passage holes 175 and 185 form a third passage 191. The third passage 191 is provided in the valve base 152 and penetrates the valve base 152 in the axial direction. The third passage 191 is formed of the communication passage 178 of the first base member 161 and the communication passage 186 of the second base member 162.

The communication passage 186 of the second base member 162 has one end that communicates with the communication passage 178 of the first base member 161. In a state in which the valve base 152 has entered the inside of the sleeve 102, the other end of the communication passage 186 of the second base member 162 communicates with the inside of the sleeve 102.

In the valve base 152, the notch part 171 of the first base member 161 and the notch part 181 of the second base member 162 form a disposition groove 195 (ring accommodating groove). The disposition groove 195 is provided at a portion on an outer circumferential side of both the first base member 161 and the second base member 162 and on a side of a lower end surface 161b and an upper end surface 162a at which the first base member 161 and the second base member 162 are in contact with each other. The disposition groove 195 is recessed inward in the radial direction of the valve base 152 from an outer circumferential surface of the valve base 152. The disposition groove 195 has an annular shape. The disposition groove 195 opens outward in the radial direction. The plurality of groove parts 182 open to the disposition groove 195. The communication passage 178 of the first base member 161 is provided on an inner side of the disposition groove 195 in the radial direction of the first base member 161. The communication passage 186 of the second base member 162 is provided on an inner side of the disposition groove 195 in the radial direction of the second base member 162.

Further, the disposition groove 195 is provided at a portion on an outer circumferential side of the first base member 161 and on the lower end surface 161b side of the first base member 161 that is in contact with the upper end surface 162a of the second base member 162. Alternatively, the disposition groove 195 may be provided at a portion on an outer circumferential side of the second base member 162 and on the upper end surface 162a side of the second base member 162 that is in contact with the lower end surface 161b of the first base member 161. That is, the disposition groove 195 is provided on an outer circumferential side of at least one of the first base member 161 and the second base member 162, and on a side of the lower end surface 161b and upper end surface 162a at which the first base member 161 and the second base member 162 are in contact with each other.

The fitting member 153 has an annular shape. The fitting member 153 has an outer diameter larger than an outer diameter of the valve base 152. The fitting member 153 is disposed between the notch part 171 and the notch part 181 when the first base member 161 and the second base member 162 are assembled to the extender 42. Thereby, the fitting member 153 is disposed in the disposition groove 195 of the valve base 152. The fitting member 153 is movable in the axial direction with respect to the valve base 152 in the disposition groove 195. In the valve base 152, the disposition groove 195 accommodates the fitting member 153. The fitting member 153 is made of brass or glass fiber-reinforced plastic.

An interposing member 197 is provided between an inner circumferential portion of the fitting member 153 and a bottom portion of the disposition groove 195. The interposing member 197 coaxially holds the fitting member 153 with respect to the valve base 152. The interposing member 197 has an axial passage 196 penetrating therethrough in the axial direction. The interposing member 197 is, for example, cylindrical and has a shape in which a plurality of grooves penetrating an outer circumferential portion in the axial direction are formed. The interposing member 197 is press-fitted in the inner circumferential portion of the fitting member 153. Thereby, the interposing member 197 is fixed to the fitting member 153. The plurality of grooves formed in the outer circumferential portion of the interposing member 197 form the axial passage 196.

The third damping valve 154 is a disc valve constituted by laminating a plurality of annular discs. The fitting shaft part 66 of the extender 42 is fitted to a radially inner side of the third damping valve 154. The third damping valve 154 is disposed between the main shaft part 61 of the extender 42 and the valve base 152. The third damping valve 154 is placed on the valve seat 177 of the valve base 152. In other words, the valve base 152 has the valve seat 177, on which the third damping valve 154 is placed, formed on the upper end surface 161a facing the piston 18. The third damping valve 154 opens the third passage 191 when a portion on the outer circumferential side is separated from the valve seat 177 of the valve base 152. The third damping valve 154 closes the third passage 191 when the portion on the outer circumferential side comes in contact with the valve seat 177 of the valve base 152.

A nut 201 is screwed onto the screw shaft part 65 of the extender 42. The second valve assembly 151 including the valve base 152 and the third damping valve 154 is attached to the mounting shaft part 62 of the extender 42 with the nut 201. Therefore, as shown in FIG. 2, the second valve assembly 151 is provided on the first valve assembly 31 side with respect to the piston assembly 17 of the piston rod 21. The valve base 152 is fixed to the piston rod 21. Therefore, the valve base 152 and the piston rod 21 move together. The valve base 152 and the third damping valve 154 are disposed in the piston rod 21. The sleeve 102 can accommodate the valve base 152.

Here, when the piston rod 21 is in a first predetermined range in which the second valve assembly 151 is disposed above the sleeve 102 and is not fitted to the sleeve 102, the inside of the cup 101 becomes the second chamber 20 as a whole.

From this state, in the compression stroke, the piston rod 21 moves to a second predetermined range on the base adapter 103 side from the first predetermined range. Then, the second valve assembly 151 enters the sleeve 102 from the enlarged diameter part 112 side of the sleeve 102. In other words, the sleeve 102 has the enlarged diameter part 112 on a side into which the second valve assembly 151 including the valve base 152 is inserted. When the second valve assembly 151 enters the sleeve 102 from the enlarged diameter part 112 side of the sleeve 102, the fitting member 153 is fitted into the sleeve 102. At the beginning of this fitting, the fitting member 153 moves upward relative to the disposition groove 195 of the valve base 152 due to a frictional force with the sleeve 102 in contact therewith. As a result, an upper surface of the fitting member 153 is brought into contact with the valve base 152. Then, the axial passage 196 is closed. In the compression stroke thereafter, the fitting member 153 is pushed by the valve base 152 while the axial passage 196 remains closed, and slides in the sleeve 102 to the base adapter 103 side.

When the fitting member 153 of the second valve assembly 151 is fitted into the sleeve 102, the second chamber 20 is divided into a fourth chamber 211 and a fifth chamber 212. The fourth chamber 211 is a portion between the second valve assembly 151 and the base adapter 103 in the cup 101. The fifth chamber 212 is a portion of the second chamber 20 excluding the fourth chamber 211. The fifth chamber 212 includes a portion between the tube 3 and the cup 101 and a portion between the piston assembly 17 and the second valve assembly 151.

In the compression stroke in the second predetermined range, the second valve assembly 151, together with the piston rod 21, moves to the base adapter 103 side while the axial passage 196 is closed as described above. At an upper portion of the second predetermined range, the fitting member 153 is at a position of the plurality of grooves 116 provided in the sleeve 102 and allows the oil fluid L to flow from the fourth chamber 211 to the fifth chamber 212 through the plurality of grooves 116. At that time, as the second valve assembly 151 approaches the base adapter 103, among the plurality of grooves 116, the number of grooves 116 through which the oil fluid L flows from the fourth chamber 211 to the fifth chamber 212 decreases, and finally becomes zero.

Also, in the compression stroke in the second predetermined range, the second valve assembly 151 moves to the base adapter 103 side while the axial passage 196 is closed as described above. At that time, the third damping valve 154 opens depending on a piston speed which is a moving speed of the piston rod 21, the piston 18, and the valve base 152 with respect to the tube 3. Then, the oil fluid L flows from the fourth chamber 211 to the fifth chamber 212 through the third passage 191. Thereby, the third damping valve 154 suppresses an excessive increase in pressure in the fourth chamber 211. The third damping valve 154 is provided in the third passage 191 and allows the oil fluid L to flow from the fourth chamber 211 to the fifth chamber 212 while generating a damping force by suppressing the flow of the oil fluid L that occurs during the compression stroke. Here, the third damping valve 154 has higher rigidity than the second damping valve 76 and is difficult to open. Therefore, the third damping valve 154 opens later than the second damping valve 76 and generates a higher damping force than the second damping valve 76.

With the fitting member 153 fitted in the sleeve 102 of the cup 101, the second valve assembly 151, together with the piston rod 21, moves to a side opposite to the base adapter 103. Then, the fitting member 153 moves downward relative to the disposition groove 195 of the valve base 152 due to the frictional force with the sleeve 102. As a result, the upper surface of the fitting member 153 is separated from the valve base 152. Thereby, the axial passage 196 opens. In the extension stroke thereafter, the fitting member 153 is pushed by the valve base 152 while the axial passage 196 remains open, and slides in the sleeve 102 to a side opposite to the base adapter 103. When the second valve assembly 151 moves to a side opposite to the base adapter 103, the oil fluid Lis allowed to flow from the fifth chamber 212 to the fourth chamber 211, from the axial passage 196 through the passages in the groove parts 182 of the valve base 152. Thereby, a resistance force to movement of the piston rod 21 in an extension direction is reduced.

The second valve assembly 151 is separated from the base adapter 103 by a predetermined distance during the extension stroke from a state in which the fitting member 153 is on the base adapter 103 side with respect to all the grooves 116 in the sleeve 102. Then, the grooves 116 provided in the sleeve 102 open to the fourth chamber 211. Then, the oil fluid L flows from the fifth chamber 212 to the fourth chamber 211 through the grooves 116. At that time, as the second valve assembly 151 becomes further away from the base adapter 103, among the plurality of grooves 116, the number of grooves 116 through which the oil fluid L flows from the fifth chamber 212 to the fourth chamber 211 increases. Thereby, the resistance force to the movement of the piston rod 21 in the extension direction is reduced in stages.

Next, main operations of the shock absorber 1 will be described.

“Extension stroke in which piston rod 21 is in first predetermined range”

{First Region in Which Piston Speed is Lower than First Predetermined Value}

In this first region of the extension stroke, the oil fluid L from the first chamber 19 flows to the second chamber 20 from the first passage 71 through the fixed orifice (not shown) between the first damping valve 75 and the piston 18 in the piston assembly 17. Therefore, in the first region of the extension stroke, a damping force having orifice characteristics (in which the damping force is substantially proportional to the square of the piston speed) is generated.

{Second Region in Which Piston Speed is Equal to or Higher than First Predetermined Value}

In this second region of the extension stroke, the oil fluid L from the first chamber 19 flows to the second chamber 20 by opening the first damping valve 75 from the first passage 71 in the piston assembly 17. Therefore, in the second region of the extension stroke, a damping force having valve characteristics (in which the damping force is substantially proportional to the piston speed) due to the first damping valve 75 is generated.

“Compression stroke in which piston rod 21 is in first predetermined range”

{Third Region in Which Piston Speed is Lower than Second Predetermined Value}

In this third region of the compression stroke, the oil fluid L from the second chamber 20 flows to the first chamber 19 from the second passage 72 through the fixed orifice (not shown) between the second damping valve 76 and the piston 18 in the piston assembly 17. Therefore, in the third region of the compression stroke, a damping force having orifice characteristics is generated.

{Fourth Region in Which Siston speed is Equal to or Higher than Second Predetermined Value}

In this fourth region of the compression stroke, the oil fluid L from the second chamber 20 flows to the first chamber 19 by opening the second damping valve 76 from the second passage 72 in the piston assembly 17. Therefore, in the fourth region of the compression stroke, a damping force having valve characteristics due to the second damping valve 76 is generated.

“Compression stroke in which piston rod 21 is in second predetermined range”

In this compression stroke, the piston assembly 17 operates in the same manner as in the first predetermined range. In addition, the second valve assembly 151 moves to the base adapter 103 side in the axial direction of the tube 3 to cause the fitting member 153 to be fitted into the sleeve 102. Then, the fitting member 153 closes the axial passage 196 at the beginning thereof.

With the axial passage 196 closed in this way, the second valve assembly 151 moves to the base adapter 103 side. Then, the oil fluid L flows from the fourth chamber 211 to the fifth chamber 212 through the plurality of grooves 116 provided in the sleeve 102. At that time, as the second valve assembly 151 approaches the base adapter 103, among the plurality of grooves 116, the number of grooves 116 through which the oil fluid L flows from the fourth chamber 211 to the fifth chamber 212 decreases, and finally becomes zero. Thereby, a damping force of the second valve assembly 151 increases in stages, and a resistance force to movement of the piston rod 21 in a compression direction increases in stages. Here, a length of a press-fitting axis between the press-fitting part 122 of the base adapter 103 and the sleeve 102 is set so that the sleeve 102 does not come off from the press-fitting part 122 even when the fourth chamber 211 reaches a maximum pressure.

Here, when the second valve assembly 151 moves to the base adapter 103 side, the third damping valve 154 opens depending on the piston speed. Then, the oil fluid L flows from the fourth chamber 211 to the fifth chamber 212 through the third passage 191. Thereby, an excessive increase in pressure in the fourth chamber 211 is suppressed.

“Extension stroke in which piston rod 21 is in second predetermined range”

In this extension stroke, the piston assembly 17 operates in the same manner as in the first predetermined range. In addition, the second valve assembly 151 moves to a side opposite to the base adapter 103. Then, the fitting member 153 opens the axial passage 196 at the beginning thereof.

With the axial passage 196 opened in this way, the second valve assembly 151 moves to a side opposite to the base adapter 103. Then, the oil fluid L flows from the fifth chamber 212 to the fourth chamber 211 through the axial passage 196 and the passages in the groove parts 182 of the valve base 152. When the fitting member 153 of the second valve assembly 151 passes a position of the grooves 116 provided in the sleeve 102 from a state in which it is on the base adapter 103 side with respect to all the grooves 116 provided in the sleeve 102, the oil fluid L flows from the fifth chamber 212 to the fourth chamber 211 through the grooves 116. At that time, as the second valve assembly 151 becomes further away from the base adapter 103, among the plurality of grooves 116, the number of grooves 116 through which the oil fluid L flows from the fifth chamber 212 to the fourth chamber 211 increases. In other words, as the second valve assembly 151 becomes further away from the base adapter 103, the damping force becomes lower, and the resistance force to the movement of the piston rod 21 in the extension direction becomes lower.

The specification of U.S. Pat. No. 9,605,726 described above discloses a shock absorber in which a damping force is increased when a rod reaches a predetermined range on a limit side during a compression stroke in which the rod is pushed into a cylinder. Incidentally, there has been a demand to suppress an increase in cost in shock absorbers. For example, FIG. 13 of the specification of U.S. Pat. No. 9,605,726 discloses a structure in which a tube is connected to a cup and the cup is connected to a valve assembly. When the shock absorber is assembled, an axial force is input to the tube from the shell. With the structure disclosed in FIG. 13 of the specification of U.S. Pat. No. 9,605,726 , the axial force of the tube should be received by the cup. Therefore, it is necessary to increase a strength of the cup. As a result, the costs increase.

The shock absorber 1 of the first embodiment includes the tube 3, the first valve assembly 31, the piston assembly 17, the piston rod 21, the cup 101, and the second valve assembly 151. The tube 3 has the inner chamber 6 inside. The first valve assembly 31 is connected to one end of the tube 3 in the axial direction. The piston assembly 17 divides the inner chamber 6 into the first chamber 19 and the second chamber 20. The piston rod 21 extends from the tube 3 through the first chamber 19 with the piston assembly 17 connected to an intermediate position thereof in the axial direction. The cup 101 is provided in the second chamber 20. The second valve assembly 151 is disposed in the second chamber 20 to be connected to the piston rod 21 and enters and exits from the cup 101. The cup 101 includes the sleeve 102 and the base adapter 103. The sleeve 102 is disposed in the second chamber 20 with a gap between itself and the tube 3 in the radial direction. The base adapter 103 is fixed to the sleeve 102 by press fitting and provided between the sleeve 102 and the first valve assembly 31.

When the shock absorber 1 is assembled, an axial force is input to the tube 3 from the swaged part 35 and the bottom part 12 of the shell 5 via the seal member 24, the rod guide 23, and the first valve assembly 31. In the shock absorber 1, the first valve assembly 31 is connected to one end of the tube 3 in the axial direction. Therefore, the axial force to the tube 3 can be received by the first valve assembly 31. Thereby, there is no need for the base adapter 103 to receive the axial force of the tube 3. Therefore, a strength of the base adapter 103 can be made low compared to when receiving the axial force of the tube 3. As a result, since a degree of freedom in material of the base adapter 103 is increased, a low-cost material can be selected. Therefore, an increase in costs of the shock absorber 1 can be suppressed. Also, a lightweight material can be selected for the base adapter 103. Therefore, an increase in weight of the shock absorber 1 can be suppressed.

In the shock absorber 1, the base adapter 103 is fixed to the sleeve 102 by press fitting. Therefore, the base adapter 103 and the sleeve 102 can be integrated before being assembled to the shock absorber 1. Therefore, since the base adapter 103 and the sleeve 102 can be handled as a single part, handling is facilitated, and assembly to the shock absorber 1 is also facilitated.

The shock absorber 1 includes the press-fitting part 122 press-fitted into the sleeve 102 provided at one end of the base adapter 103 in the axial direction, and the leg part 123 placed on the first valve assembly 31 provided at the other end of the base adapter 103 in the axial direction. The communication passage 142 that allows the third chamber 141 between the first valve assembly 31 and the base adapter 103 to communicate with the second chamber 20 is provided in the leg part 123. Since the communication passage 142 is provided in the leg part 123 in this way, a gap in the radial direction between the tube 3 and the sleeve 102 can be reduced compared to a case in which the communication passage is provided on a side inward from the leg part 123 in the radial direction of the main plate part 121.

In the shock absorber 1, the inner circumferential portion 135 of the leg part 123 increases in diameter toward the first valve assembly 31. As a result, an outer diameter of the disc valve 83 of the first valve assembly 31 can be increased compared to a case in which the inner circumferential portion 135 has a constant diameter. Therefore, a variable width of the damping force of the disc valve 83 can be increased. Particularly, when the disc valve 83 is used as a suction valve that substantially does not generate a damping force, the damping force can be brought close to zero by increasing the diameter of the disc valve 83.

U.S. Pat. No. 9,651,110 discloses a configuration in which a second piston member as a hydraulic stopper mechanism for extension-side hydraulic lock is provided in a piston rod in addition to a first piston member.

Japanese Unexamined Patent Application, First Publication No. 2022-133840 discloses a configuration in which a first piston member is provided on a rod and a second piston member is provided in a holder corresponding to an extension rod.

European Patent No. 2910811 discloses a configuration in which a ring is sandwiched between two members.

PCT International Publication No. WO 2017/089425 shows a configuration in which an outer circumference of a ring is used as a passage.

Incidentally, in a shock absorber, a structure that increases a damping force in the vicinity of a movement end position of the piston rod is desired to be configured with a compact structure.

The shock absorber 1 includes the tube 3, the piston rod 21 disposed in the tube 3, the piston 18, the first damping valve 75, and the second damping valve 76 disposed in the piston rod 21, the valve base 152 and the third damping valve 154 disposed in the piston rod 21, and the sleeve 102 that can accommodate the valve base 152. The valve base 152 is constituted by combining the first base member 161 and the second base member 162. The first base member 161 has the communication passage 178 inside. The first base member 161 has the valve seat 177, on which the third damping valve 154 is placed, formed on the upper end surface 161a facing the piston 18. The communication passage 178 and the communication passage 186 that communicates with the inside of the sleeve 102 are formed in the second base member 162. The disposition groove 195 accommodating the fitting member 153 is provided on an outer circumferential side of at least one of the first base member 161 and the second base member 162, and on a side of the lower end surface 161b and upper end surface 162a at which the first base member 161 and the second base member 162 are in contact with each other.

In the shock absorber 1, the valve base 152 and the fitting member 153 enter the sleeve 102 during the compression stroke. Then, the fitting member 153 moves with respect to the valve base 152 due to the frictional force with the sleeve 102 to close the axial passage 196 between itself and the valve base 152, and thereby a damping force is generated. In the shock absorber 1, when the third damping valve 154 is provided in the valve base 152, if a hydraulic pressure in the fourth chamber 211 becomes higher than a predetermined pressure during the compression stroke, the third damping valve 154 opens to relieve the hydraulic pressure in the fourth chamber 211 to the fifth chamber 212 via the communication passages 178 and 186. Thereby, the shock absorber 1 can suppress an excessive increase in hydraulic pressure during the compression stroke in which the valve base 152 enters the sleeve 102 to generate a damping force. Also, during the extension stroke in the shock absorber 1, the fitting member 153 moves with respect to the valve base 152 due to the frictional force with the sleeve 102 to open the axial passage 196 between itself and the valve base 152, and thereby the oil fluid Lis allowed to flow smoothly from the fifth chamber 212 to the fourth chamber 211. Thereby, in the shock absorber 1, movement of the valve base 152 and the fitting member 153 in the sleeve 102 is made smooth during the extension stroke.

In the shock absorber 1, the valve base 152, the fitting member 153, and the third damping valve 154, which increase the damping force in the vicinity of the compression-side movement end position of the piston rod 21 as described above, can be put together into a compact configuration.

In the shock absorber 1, the fitting member 153 is made of brass or glass fiber-reinforced plastic.

In the shock absorber 1, the sleeve 102 has the enlarged diameter part 112 on a side into which the second base member 162 is inserted. Thereby, the shock absorber 1 can smoothly increase the damping force when increasing the damping force at the vicinity of the compression-side movement end position of the piston rod 21.

### Second Embodiment

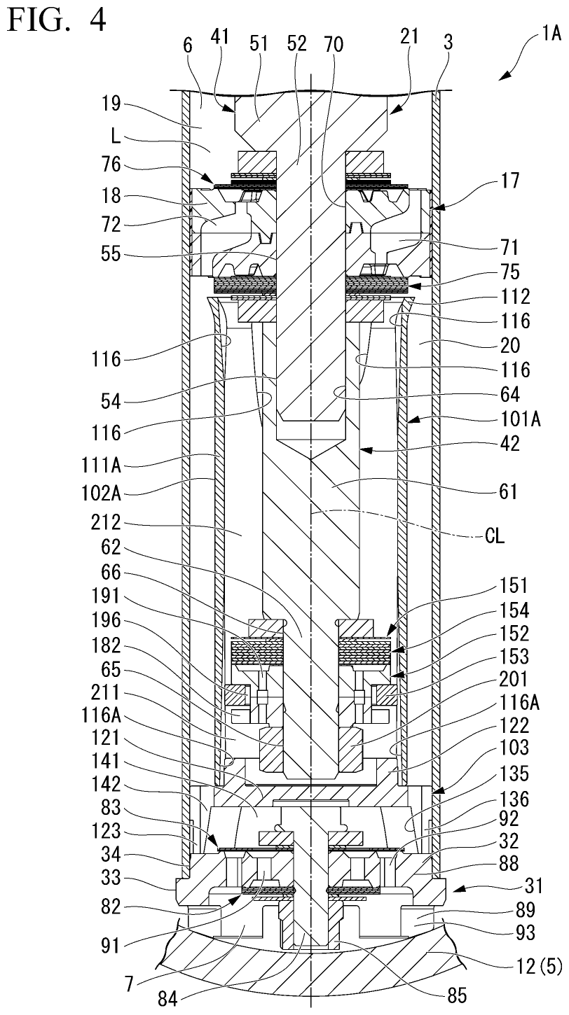

Next, a shock absorber of a second embodiment will be described mainly on the basis of FIG. 4, focusing on differences from the first embodiment. Further, parts common to those in the first embodiment will be denoted by the same terms and the same reference signs. Also, reference sign CL denoted in each figure indicates a central axis of the shock absorber.

A shock absorber 1A of the second embodiment includes a cup 101A that is partially different from the cup 101 instead of the cup 101. The cup 101A includes a sleeve 102A (second tube) that is partially different from the sleeve 102 instead of the sleeve 102. The sleeve 102A includes a main body part 111A that is partially different from the main body part 111 instead of the main body part 111.

As in the sleeve 102, a plurality of grooves 116 extending in an axial direction of the sleeve 102A are provided at an inner circumferential portion on one end side of the sleeve 102A in the axial direction. A groove 116A extending in the axial direction of the sleeve 102A is also provided at an inner circumferential portion on the other end side of the sleeve 102A in the axial direction. The groove 116A is provided on an inner circumferential portion of a lower end of the sleeve 102A. The groove 116A is recessed outward in a radial direction of the sleeve 102A from an inner circumferential surface of the sleeve 102A. A plurality of grooves 116A are provided in the sleeve 102A at regular intervals in the circumferential direction of the sleeve 102A. The plurality of grooves 116A have the same length from the lower end of the sleeve 102A. In other words, the plurality of grooves 116A have the same length in the axial direction of the sleeve 102A.

A press-fitting part 122 of a base adapter 103 is press-fitted into the lower end portion of the sleeve 102A. At that time, an upper surface of a main plate part 121 comes in contact with the lower end portion of the sleeve 102A. Thereby, lower ends of the plurality of grooves 116A are closed and the base adapter 103 is fixed to the sleeve 102A. The plurality of grooves 116A extend above the press-fitting part 122.

A piston rod 21 moves from a first predetermined range in which a second valve assembly 151 is not fitted in the sleeve 102A to a second predetermined range in a compression stroke. Then, the second valve assembly 151 causes a fitting member 153 to be fitted into the sleeve 102A. At the beginning of this fitting, the fitting member 153 closes an axial passage 196.

In the compression stroke in the second predetermined range, the second valve assembly 151, together with the piston rod 21, moves to the base adapter 103 side while the axial passage 196 is closed as described above. At an upper portion of the second predetermined range, the fitting member 153 is at a position of the plurality of grooves 116 provided in the sleeve 102A and allows an oil fluid L to flow from a fourth chamber 211 to a fifth chamber 212 through the plurality of grooves 116. At that time, as the second valve assembly 151 approaches the base adapter 103 side, among the plurality of grooves 116, the number of grooves 116 through which the oil fluid L flows from the fourth chamber 211 to the fifth chamber 212 decreases, and finally becomes zero.

Also, in the compression stroke in the second predetermined range, the second valve assembly 151 moves to the base adapter 103 side while the axial passage 196 is closed as described above. At that time, a third damping valve 154 opens depending on a piston speed. Then, the oil fluid L flows from the fourth chamber 211 to the fifth chamber 212 through a third passage 191. Thereby, the third damping valve 154 suppresses an excessive increase in pressure in the fourth chamber 211.

Here, in the compression stroke, when the second valve assembly 151 approaches a lower limit position of the second predetermined range, the fitting member 153 is positioned at a position of the plurality of grooves 116A provided in the sleeve 102A. Then, the oil fluid L flows from the fourth chamber 211 to the fifth chamber 212 through the plurality of grooves 116A provided in the sleeve 102A. Thereby, the plurality of grooves 116A suppress an excessive increase in pressure in the fourth chamber 211.

From this state, the second valve assembly 151, together with the piston rod 21, moves to a side opposite to the base adapter 103. Then, the fitting member 153 opens the axial passage 196. In this state, when the second valve assembly 151 moves to a side opposite to the base adapter 103, the oil fluid L is allowed to flow from the fifth chamber 212 to the fourth chamber 211, from the axial passage 196 through a passage in a groove part 182 of a valve base 152. At the same time, the oil fluid L is allowed to flow from the fifth chamber 212 to the fourth chamber 211 through the plurality of grooves 116A. Thereby, a resistance force to movement of the piston rod 21 in an extension direction is reduced.

When the fitting member 153 is positioned on a side opposite to the base adapter 103 with respect to all the grooves 116A in the sleeve 102A, the second valve assembly 151 allows the oil fluid L to flow from the fifth chamber 212 to the fourth chamber 211 only through a flow path from the axial passage 196 through the passage in the groove part 182 of the valve base 152.

In the shock absorber 1A of the second embodiment, the grooves 116 extending in the axial direction of the sleeve 102A are provided at an inner circumferential portion on one end side of the sleeve 102A in the axial direction, and the grooves 116A extending in the axial direction of the sleeve 102A are provided at an inner circumferential portion on the other end side of the sleeve 102A in the axial direction. Thereby, at the beginning of the compression stroke in the second predetermined range, a rate of change in damping force becomes gentle due to the grooves 116 on the upper end side. Since there is no groove in the middle of the sleeve 102A in the axial direction, the damping force increases at the middle position in the second predetermined range of the compression stroke. On the lower end side of the second predetermined range, an increase in damping force is suppressed by the grooves 116A. The grooves 116A can serve the role of a relief.

Further, in the embodiments, a hydraulic shock absorber has been shown as an example of the shock absorbers 1 and 1A, but the above-described structure can also be employed for a shock absorber using water or air as a working fluid.

### Third Embodiment

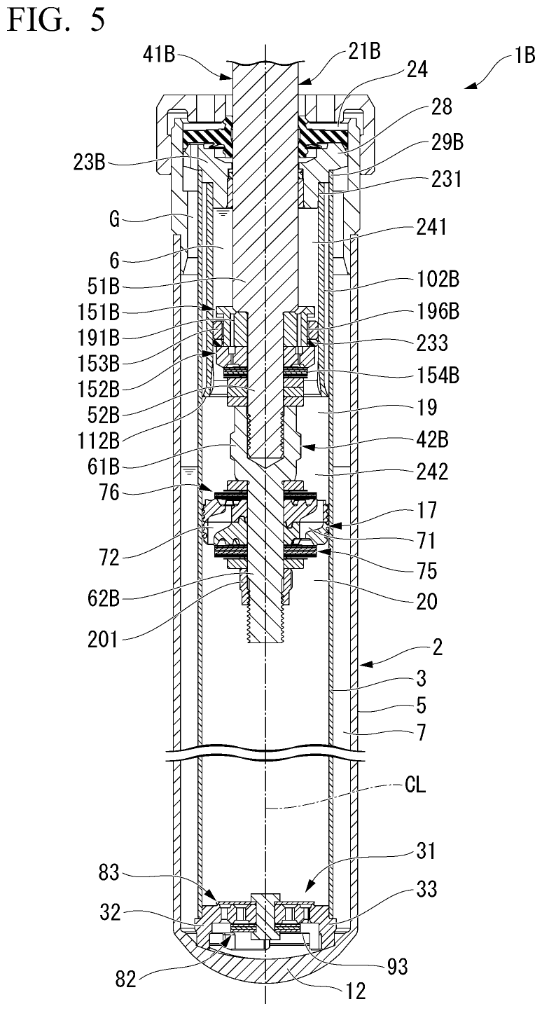

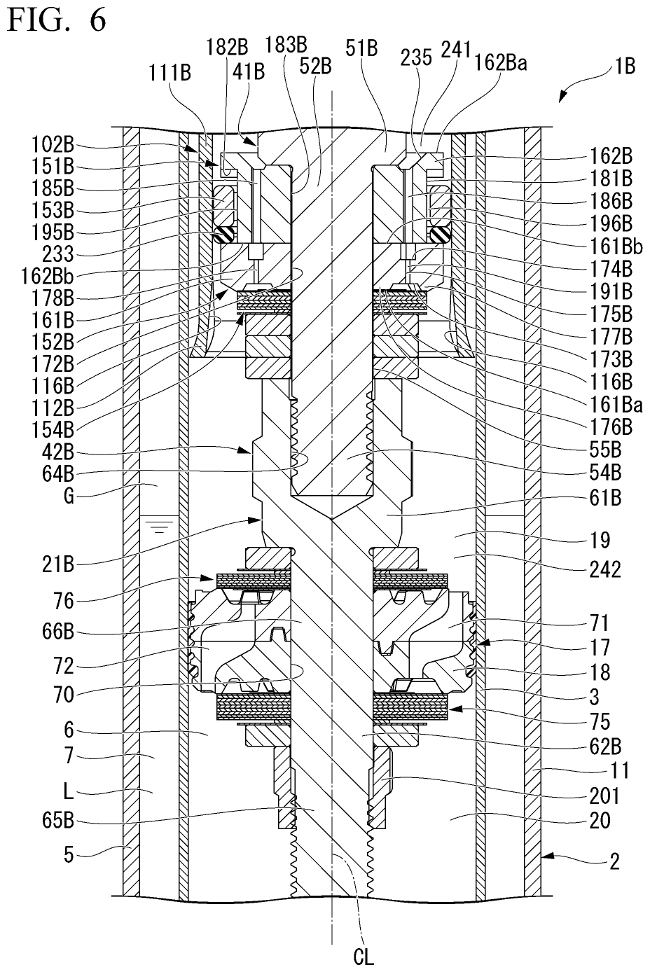

Next, a shock absorber of a third embodiment will be described mainly on the basis of FIGS. 5 and 6, focusing on differences from the first embodiment. Parts common to those in the first embodiment will be denoted by the same terms and the same reference signs. Also, reference sign CL denoted in each figure indicates a central axis of the shock absorber.

As illustrated in FIG. 5, a shock absorber 1B of the third embodiment does not include the cup 101 that has been included in the shock absorber 1 of the first embodiment. The shock absorber 1B includes a rod guide 23B that is partially different from the rod guide 23 instead of the rod guide 23.

The rod guide 23B has a large diameter part 28 similar to the rod guide 23, an intermediate diameter part 29B, and a small diameter part 231. The intermediate diameter part 29B has an outer diameter smaller than an outer diameter of the large diameter part 28. The small diameter part 231 has an outer diameter smaller than the outer diameter of the intermediate diameter part 29B. In the rod guide 23B, the intermediate diameter part 29B is provided below the large diameter part 28. In the rod guide 23B, the small diameter part 231 is provided below the intermediate diameter part 29B. The rod guide 23B is fitted to an upper inner circumferential portion of a shell 5 at the upper large diameter part 28. The rod guide 23B is fitted to an inner circumferential portion of an upper end of a tube 3 at the intermediate diameter part 29B. At that time, an upper end portion of the tube 3 is in contact with the large diameter part 28 in an axial direction of the tube 3.

The shock absorber 1B includes a sleeve 102B (second tube). The sleeve 102B is cylindrical. An outer diameter of the sleeve 102B is smaller than an inner diameter of the tube 3. The sleeve 102B is disposed inside of the tube 3 in a radial direction. The sleeve 102B is fitted to the small diameter part 231 of the lower portion of the rod guide 23B at an inner circumferential portion of an upper end thereof. At that time, an upper end portion of the sleeve 102B comes into contact with the intermediate diameter part 29B in an axial direction of the sleeve 102B. A central axis of the sleeve 102B coincides with a central axis of the tube 3. The sleeve 102B is disposed in a first chamber 19 with a radial gap formed between itself and the tube 3.

As illustrated in FIG. 6, the sleeve 102B has a main body part 111B and an enlarged diameter part 112B. The main body part 111B is cylindrical and provided from the upper end portion to a lower portion of the sleeve 102B. The enlarged diameter part 112B is provided at a lower end portion of the sleeve 102B. An inner diameter of the enlarged diameter part 112B increases toward the lower end. An outer diameter of the enlarged diameter part 112B increases toward the lower end. The enlarged diameter part 112B increases in diameter in a direction away from the main body part 111B in the axial direction of the sleeve 102B.

The sleeve 102B has a groove 116B provided to extend in the axial direction of the sleeve 102B at an inner circumferential portion on one end side in the axial direction. The groove 116B is provided at an inner circumferential portion on a lower end side of the sleeve 102B. The groove 116B is recessed outward in the radial direction of the sleeve 102B from an inner circumferential surface of the sleeve 102B. The groove 116B extends from the enlarged diameter part 112B to a lower portion of the main body part 111B. A plurality of grooves 116B are provided in the sleeve 102B at regular intervals in a circumferential direction of the sleeve 102B. The plurality of grooves 116B have different lengths from the lower end of the sleeve 102B. In other words, the plurality of grooves 116B have different lengths in the axial direction of the sleeve 102B.

The shock absorber 1B includes a piston rod 21B, which is partially different from the piston rod 21, instead of the piston rod 21. The piston rod 21B includes a rod main body 41B and an extender 42B.

The rod main body 41B has a main shaft part 51B and a mounting shaft part 52B. Both the main shaft part 51B and the mounting shaft part 52B have a rod shape. The mounting shaft part 52B has an outer diameter smaller than an outer diameter of the main shaft part 51B. The mounting shaft part 52B extends from one end of the main shaft part 51B in the axial direction. A central axis of the mounting shaft part 52B coincides with a central axis of the main shaft part 51B. The mounting shaft part 52B is disposed inside the tube 3 in its entirety. In the piston rod 21B, as illustrated in FIG. 5, the main shaft part 51B of the rod main body 41B slides with respect to the rod guide 23B and a seal member 24 in the axial direction of them.

As illustrated in FIG. 6, in the mounting shaft part 52B, an end portion on a side opposite to the main shaft part 51B in the axial direction of the mounting shaft part 52B serves as a screw shaft part 54B. The screw shaft part 54B has a male screw formed on an outer circumferential portion. A portion of the mounting shaft part 52B between the main shaft part 51B and the screw shaft part 54B in the axial direction of the mounting shaft part 52B serves as a fitting shaft part 55B. An outer circumferential surface of the fitting shaft part 55B is a cylindrical surface.

The extender 42B has a base shaft part 61B and a mounting shaft part 62B. Both the base shaft part 61B and the mounting shaft part 62B have a rod shape. The mounting shaft part 62B has an outer diameter smaller than an outer diameter of the base shaft part 61B. The mounting shaft part 62B extends from one end of the base shaft part 61B in the axial direction. A central axis of the mounting shaft part 62B coincides with a central axis of the base shaft part 61B.

The base shaft part 61B has a screw hole 64B formed from an end portion on a side opposite to the mounting shaft part 62B in the axial direction of the base shaft part 61B to an intermediate portion. The screw hole 64B is formed at a center position in the radial direction of the base shaft part 61B. The screw hole 64B extends in the axial direction of the base shaft part 61B. The screw hole 64B opens upward.

In the mounting shaft part 62B, an end portion on a side opposite to the base shaft part 61B in the axial direction of the mounting shaft part 62B serves as a screw shaft part 65B. The screw shaft part 65B has a male screw formed on an outer circumferential portion. A portion of the mounting shaft part 62B between the base shaft part 61B and the screw shaft part 65B in the axial direction of the mounting shaft part 62B is a fitting shaft part 66B. An outer circumferential surface of the fitting shaft part 66B is a cylindrical surface.

In the rod main body 41B, the screw shaft part 54B thereof is screwed into the screw hole 64B of the extender 42B. Thereby, the rod main body 41B and the extender 42B are connected with their central axes coincided with each other. Thereby, the piston rod 21B is formed. The extender 42B is disposed inside the tube 3 in its entirety. In the rod main body 41B, a portion thereof connected to the extender 42B is disposed inside the tube 3, and a side opposite to the extender 42B extends to the outside from a cylinder 2.

In the piston rod 21B, a piston assembly 17 formed of a piston 18 (primary piston), a first damping valve 75 (first valve), and a second damping valve 76 is attached to the mounting shaft part 62B of the extender 42B. At that time, the piston assembly 17 is fitted to the fitting shaft part 66B of the extender 42B. The piston assembly 17 is attached to the extender 42B with a nut 201 that is screwed onto the screw shaft part 65B of the extender 42B. The piston 18, the first damping valve 75, and the second damping valve 76 are disposed on the piston rod 21B. The piston assembly 17 formed of the piston 18, the first damping valve 75, and the second damping valve 76 is provided on a distal end side of the piston rod 21B.

The shock absorber 1B has a second valve assembly 151B. The second valve assembly 151B is disposed in the first chamber 19 and connected to the piston rod 21B. The second valve assembly 151B is attached to the mounting shaft part 52B of the rod main body 41B. The second valve assembly 151B enters the sleeve 102B from below through an opening at the lower end of the sleeve 102B and exits therefrom downward.

The second valve assembly 151B includes a valve base 152B (secondary piston), a first fitting member 153B (ring), a second fitting member 233 (ring), and a third damping valve 154B (second valve).

The valve base 152B has a first base member 161B (first piston member) and a second base member 162B (second piston member). The valve base 152B is constituted by combining the first base member 161B and the second base member 162B. The first base member 161B constitutes a lower portion of the valve base 152B. The second base member 162B constitutes an upper portion of the valve base 152B.

The first base member 161B has an annular shape. The first base member 161B has a through hole 172B formed at a center in a radial direction thereof. The through hole 172B penetrates the first base member 161B in an axial direction of the first base member 161B. The fitting shaft part 55B of the rod main body 41B is fitted into the through hole 172B of the first base member 161B. A passage groove 173B is provided in the first base member 161B on a side outward from the through hole 172B in a radial direction of the first base member 161B. A passage groove 174B and a passage hole 175B are provided in the first base member 161B on a side outward from the through hole 172B in the radial direction of the first base member 161B.

The passage groove 173B is formed at a lower end portion of the first base member 161B. The passage groove 173B is recessed upward from a lower end surface 161Ba (one end surface) of the first base member 161B. The passage groove 173B has an annular shape that surrounds the through hole 172B from an outer side in the radial direction. The passage groove 173B opens downward.

In the lower end portion of the first base member 161B, a portion on an inner side of the passage groove 173B in the radial direction of the first base member 161B serves as an annular inner seat 176B, and a portion on an outer side of the passage groove 173B serves as an annular valve seat 177B (seat). The inner seat 176B and the valve seat 177B are formed on the first base member 161B on the lower end surface 161Ba which is one end surface facing the piston 18.

The passage groove 174B is formed at an upper end portion of the first base member 161B. The passage groove 173B is recessed downward from an upper end surface 161Bb (contact surface) of the first base member 161B. The passage groove 174B has an annular shape that surrounds the through hole 172B from an outer side in the radial direction. The passage groove 174B opens upward.

The passage hole 175B is formed at an intermediate portion in the axial direction of the first base member 161B. A lower end of the passage hole 175B opens at a bottom position of the passage groove 173B and an upper end thereof opens at a bottom position of the passage groove 174B. A plurality of passage holes 175B are formed in the first base member 161B at intervals in a circumferential direction of the first base member 161B.

In the first base member 161B, a passage in the passage groove 173B, passages in the plurality of passage holes 175B, and a passage in the passage groove 174B constitute a communication passage 178B (first communication passage) that penetrates the first base member 161B in the axial direction. The first base member 161B has the communication passage 178B inside or on an inner circumferential surface side, not on a surface on an outer circumferential side. Specifically, the first base member 161B has the communication passage 178B inside. The first base member 161B may have the communication passage 178B between itself and the inner circumferential surface side, that is, the fitting shaft part 55B of the rod main body 41B.

The second base member 162B has an annular shape. A notch part 181B is formed in the second base member 162B from an intermediate portion in the axial direction to an outer circumferential portion on a lower side. The notch part 181B is formed over the entire circumference of the second base member 162B. The notch part 181B has an annular shape.

A groove part 182B is formed at a lower portion of a flange-shaped portion at an upper portion of the second base member 162B. The groove part 182B is recessed upward from a lower surface of the flange-shaped portion of the second base member 162B. The groove part 182B opens outward in a radial direction of the second base member 162. The groove part 182B opens to the notch part 181B. A plurality of groove parts 182B are formed in the second base member 162B at intervals in a circumferential direction of the second base member 162B.

The second base member 162B has a through hole 183B formed at a center in a radial direction thereof. The through hole 183B penetrates the second base member 162B in an axial direction of the second base member 162B. The fitting shaft part 55B of the rod main body 41B is fitted in the through hole 183B of the second base member 162B. Then, the second base member 162B is in contact with an end surface of the main shaft part 51B of the rod main body 41B on the mounting shaft part 52B side at an upper surface 162Ba. The second base member 162B includes a passage hole 185B provided between the through hole 183B and the notch part 181B in a radial direction of the second base member 162B. A passage groove 235 is provided in the second base member 162B on a side outward from the through hole 183B in the radial direction of the second base member 162B.

The passage groove 235 is formed at an upper end portion of the second base member 162B. The passage groove 235 is recessed downward from the upper surface 162Ba of the second base member 162B. The passage groove 235 has an annular shape that surrounds the through hole 183B from an outer side in the radial direction. The passage groove 235 opens upward. The passage groove 235 opens outward in the radial direction from the main shaft part 51B of the rod main body 41B that is in contact with the upper surface 162Ba of the second base member 162B.

The passage hole 185B is formed from a bottom surface of the passage groove 235 to a lower end surface 162Bb (contact surface) of the second base member 162B. In other words, an upper end of the passage hole 185B opens at a bottom position of the passage groove 235, and a lower end thereof opens at the lower end surface 162Bb of the second base member 162B. A plurality of passage holes 185B are formed in the second base member 162B at intervals in the circumferential direction of the second base member 162B.

In the second base member 162B, a passage in the passage groove 235 and passages in the plurality of passage holes 185B constitute a communication passage 186B (second communication passage) penetrating the second base member 162B in the axial direction. The second base member 162B has the communication passage 186B inside or on an inner circumferential surface side, not on a surface on an outer circumferential side. Specifically, the second base member 162B has the communication passage 186B inside. The second base member 162B may have the communication passage 186B between itself and the inner circumferential surface side, that is, the fitting shaft part 55B of the rod main body 41B.

The first base member 161B is in contact with the lower end surface 162Bb of the second base member 162B at the upper end surface 161Bb while it is fitted to the fitting shaft part 55B of the rod main body 41B. Then, the passage groove 173B, the passage holes 175B, and the passage groove 174B of the first base member 161B communicate with the passage holes 185B and the passage groove 235 of the second base member 162B. The passage grooves 173B, 174B, and 235 and the passage holes 175B and 185B constitute a third passage 191B. The third passage 191B is provided in the valve base 152B and penetrates the valve base 152B in the axial direction. The third passage 191B is formed of the communication passage 178B of the first base member 161B and the communication passage 186B of the second base member 162B.

One end of the communication passage 186B of the second base member 162B communicates with the communication passage 178B of the first base member 161B. In a state in which the valve base 152B has entered the inside of the sleeve 102B, the other end of the communication passage 186B of the second base member 162B communicates with the inside of the sleeve 102B.

In the valve base 152B, the notch part 181B of the second base member 162B, together with the first base member 161B, forms a disposition groove 195B (ring accommodating groove). The disposition groove 195B is provided at a portion on an outer circumferential side of the second base member 162B of the first base member 161B and the second base member 162B, and on the lower end surface 162Bb side of the second base member 162B that is in contact with the upper end surface 161Bb of the first base member 161B. The disposition groove 195B is recessed inward in a radial direction of the valve base 152B from an outer circumferential surface of the valve base 152B. The disposition groove 195B is annular. The disposition groove 195B opens outward in the radial direction. The communication passage 178B of the first base member 161B is provided on an inner side of the disposition groove 195B in the radial direction of the first base member 161B. The communication passage 186B of the second base member 162B is provided on an inner side of the disposition groove 195B in the radial direction of the second base member 162B.

Further, the disposition groove 195B may be provided at a portion on an outer circumferential side of both the first base member 161B and the second base member 162B, and on a side of the upper end surface 161Bb and lower end surface 162Bb at which the first base member 161B and the second base member 162B are in contact with each other. Alternatively, the disposition groove 195B may be provided at a portion on an outer circumferential side of the first base member 161B, and on the upper end surface 161Bb side of the first base member 161B that is in contact with the lower end surface 162Bb of the second base member 162B. That is, the disposition groove 195B is provided on an outer circumferential side of at least one of the first base member 161B and the second base member 162B, and on a side of the upper end surface 161Bb and lower end surface 162Bb at which the first base member 161B and the second base member 162B are in contact with each other.

The first fitting member 153B has an annular shape. The first fitting member 153B has an outer diameter larger than an outer diameter of the valve base 152B. The first fitting member 153B is disposed between the first base member 161B and the notch part 181B of the second base member 162B when the first base member 161B and the second base member 162B are assembled to the rod main body 41B. Thereby, the first fitting member 153B is disposed in the disposition groove 195B of the valve base 152B. The first fitting member 153B is movable in the axial direction with respect to the valve base 152B in the disposition groove 195B. The valve base 152B accommodates the first fitting member 153B in the disposition groove 195B. The first fitting member 153B is made of brass or glass fiber-reinforced plastic. The first fitting member 153B has a C-shaped cross section. In other words, a slit (not illustrated) is provided in a part in the radial direction, that is, the shape is not a continuous ring. This is because the first fitting member 153B increases in diameter due to an internal pressure and comes into sliding contact with the main body part 111B of the sleeve 102B.

The second fitting member 233 has an annular shape. The second fitting member 233 has an outer diameter larger than the outer diameter of the valve base 152B. The second fitting member 233 is disposed between the first base member 161B and the notch part 181B of the second base member 162B when the first base member 161B and the second base member 162B are assembled to the rod main body 41B. Thereby, the second fitting member 233 is disposed in the disposition groove 195B of the valve base 152B. At that time, the second fitting member 233 is disposed below the first fitting member 153B. The second fitting member 233 is movable in the axial direction with respect to the valve base 152B in the disposition groove 195B. The valve base 152B accommodates the second fitting member 233 in the disposition groove 195B. The second fitting member 233 is made of an elastic material such as rubber, steel, brass, or the like. An outer diameter of the first fitting member 153B is larger than an outer diameter of the second fitting member 233. This is because the first fitting member 153B is in sliding contact with the main body part 111B of the sleeve 102B at a portion of the outer diameter thereof. The second fitting member 233 does not have a slit like that in the first fitting member 153B and has an annular shape. The second fitting member 233 plays a role of preventing an oil from flowing out of a high pressure side to a low pressure side via the slit of the first fitting member 153B. Also, an axial length of the second fitting member 233 is smaller than an axial length of the first fitting member 153B.

A gap is provided between an inner circumferential portion of the first fitting member 153B and a bottom part of the disposition groove 195B. A gap is provided between an inner circumferential portion of the second fitting member 233 and a bottom part of the disposition groove 195B. These gaps form an axial passage 196B that penetrates the first fitting member 153B and the second fitting member 233 in the axial direction.

The third damping valve 154B is a disc valve constituted by laminating a plurality of annular discs. The fitting shaft part 55B of the rod main body 41B is fitted to a radially inner side of the third damping valve 154B. The third damping valve 154B is attached to the rod main body 41B by the extender 42B that is screwed onto the screw shaft part 54B of the rod main body 41B in the screw hole 64B.

The third damping valve 154B is placed on the valve seat 177B of the valve base 152B. In other words, the valve base 152B includes the valve seat 177B, on which the third damping valve 154B is placed, formed on one end surface facing the piston 18. The third damping valve 154B opens the third passage 191B by separating a portion on an outer circumferential side from the valve seat 177B of the valve base 152B. The third damping valve 154B closes the third passage 191B by bringing the portion on the outer circumferential side into contact with the valve seat 177B of the valve base 152B.

As illustrated in FIG. 5, the second valve assembly 151B is provided on a side opposite to the first valve assembly 31 with respect to the piston assembly 17 of the piston rod 21B. The valve base 152B is fixed to the piston rod 21B. Therefore, the valve base 152B and the piston rod 21B move together. The valve base 152B and the third damping valve 154B are disposed on the piston rod 21B. The sleeve 102B can accommodate the valve base 152B.

Here, when the piston rod 21B is in a third predetermined range in which the second valve assembly 151B is disposed below the sleeve 102B and is not fitted to the sleeve 102B, the inside of the sleeve 102B serves as the first chamber 19 as a whole.

From this state, in an extension stroke, the piston rod 21B moves to a fourth predetermined range on the rod guide 23B side from the third predetermined range. Then, the second valve assembly 151B enters the sleeve 102B from the enlarged diameter part 112B side of the sleeve 102B. In other words, the sleeve 102B has the enlarged diameter part 112B on a side into which the second valve assembly 151B including the valve base 152B is inserted. When the second valve assembly 151B enters the sleeve 102B from the enlarged diameter part 112B side of the sleeve 102B, the first fitting member 153B and the second fitting member 233 are fitted into the sleeve 102B. At the beginning of this fitting, the first fitting member 153B moves downward relative to the disposition groove 195B of the valve base 152B while compressively deforming the second fitting member 233 due to a frictional force with the sleeve 102B in contact. As a result, the first fitting member 153B presses a lower surface of the second fitting member 233 against the valve base 152B. Then, the axial passage 196B is closed by the second fitting member 233. In the extension stroke thereafter, the first fitting member 153B is pushed by the valve base 152B via the second fitting member 233 while the axial passage 196B remains closed by the second fitting member 233, and slides in the sleeve 102B to the rod guide 23B side.

The first chamber 19 is divided into a third chamber 241 and a fourth chamber 242 when the first fitting member 153B and the second fitting member 233 of the second valve assembly 151B are fitted into the sleeve 102B. The third chamber 241 is a portion between the second valve assembly 151B and the rod guide 23B in the sleeve 102B. The fourth chamber 242 is a portion of the first chamber 19 excluding the third chamber 241. The fourth chamber 242 includes a portion between the tube 3 and the sleeve 102B and a portion between the piston assembly 17 and the second valve assembly 151B.

During the extension stroke in the fourth predetermined range, the second valve assembly 151B, together with the piston rod 21B, moves to the rod guide 23B side while the axial passage 196B is closed as described above. At a lower portion of the fourth predetermined range, the first fitting member 153B is at a position of the plurality of grooves 116B provided in the sleeve 102B to allow an oil fluid L to flow from the third chamber 241 to the fourth chamber 242 through the plurality of grooves 116B. At that time, as the second valve assembly 151B approaches the rod guide 23B, among the plurality of grooves 116B, the number of the grooves 116B through which the oil fluid L flows from the third chamber 241 to the fourth chamber 242 decreases and finally becomes zero.

Also, during the extension stroke in the fourth predetermined range, the second valve assembly 151B moves to the rod guide 23B side while the axial passage 196B is closed as described above. At that time, the third damping valve 154B opens depending on a piston speed which is a moving speed of the piston rod 21B, the piston 18, and the valve base 152B with respect to the tube 3. Then, the oil liquid L flows from the third chamber 241 to the fourth chamber 242 via the third passage 191B. As a result, the third damping valve 154B suppresses an excessive increase in pressure in the third chamber 241. The third damping valve 154B is provided in the third passage 191B and allows the oil fluid L to flow from the third chamber 241 to the fourth chamber 242 while generating a damping force by suppressing a flow of the oil fluid L that occurs during the extension stroke. Here, the third damping valve 154B has higher rigidity than the first damping valve 75 and is difficult to open. Therefore, the third damping valve 154B opens later than the first damping valve 75 and generates a higher damping force than the first damping valve 75.

From a state in which the first fitting member 153B and the second fitting member 233 are fitted in the sleeve 102B, the second valve assembly 151B, together with the piston rod 21B, moves to a side opposite to the rod guide 23B in a compression stroke. Then, the first fitting member 153B and the second fitting member 233 move upward relative to the disposition groove 195B of the valve base 152B due to a frictional force with the sleeve 102B. As a result, the second fitting member 233 separates the lower surface from the valve base 152B. Thereby, the axial passage 196B opens. In the compression stroke thereafter, the first fitting member 153B and the second fitting member 233 are pushed by the valve base 152B while the axial passage 196B remains open, and slide to a side opposite to the rod guide 23B in the sleeve 102B. When the second valve assembly 151B moves to a side opposite to the rod guide 23B, the oil fluid L is allowed to flow from the fourth chamber 242 to the third chamber 241 through the axial passage 196B and passages in the plurality of groove parts 182B. Thereby, a resistance force to movement of the piston rod 21B in a compression direction is reduced.

The second valve assembly 151B is separated from the rod guide 23B by a predetermined distance during the compression stroke from a state in which the first fitting member 153B and the second fitting member 233 are on the rod guide 23B side with respect to all the grooves 116B in the sleeve 102B. Then, the grooves 116B provided in the sleeve 102B open to the third chamber 241. Then, the oil fluid L flows from the fourth chamber 242 to the third chamber 241 through the grooves 116B. At that time, as the second valve assembly 151B becomes further away from the rod guide 23B, among the plurality of grooves 116B, the number of grooves 116B through which the oil fluid L flows from the fourth chamber 242 to the third chamber 241 increases. Thereby, a resistance force to movement of the piston rod 21B in the compression direction is reduced in stages.

Next, main operations of the shock absorber 1B will be described.

“Extension stroke in which piston rod 21B is in third Ppedetermined range”

{Fifth Region in Which Piston Speed is Lower than Third Predetermined Value}

In this fifth region of the extension stroke, the oil fluid L from the first chamber 19 flows to a second chamber 20 from the first passage 71 through a fixed orifice (not illustrated) between the first damping valve 75 and the piston 18 in the piston assembly 17. Therefore, in the fifth region of the extension stroke, a damping force having orifice characteristics is generated.

{Sixth Region in Which Piston Speed is Equal to or Higher than Third Predetermined Value}

In the sixth region of the extension stroke, the oil fluid L from the first chamber 19 flows from the first passage 71 into the second chamber 20 by opening the first damping valve 75 in the piston assembly 17. Therefore, in the sixth region of the extension stroke, a damping force having valve characteristics due to the first damping valve 75 is generated.

“Compression stroke in which the piston rod 21B is in third predetermined range”

{Seventh Region in Which Piston Speed is Lower than Fourth Predetermined Value}

In this seventh region of the compression stroke, the oil fluid L from the second chamber 20 flows into the first chamber 19 from the second passage 72 through a fixed orifice (not illustrated) between the second damping valve 76 and the piston 18 in the piston assembly 17. Therefore, in the seventh region of the compression stroke, a damping force having orifice characteristics is generated.

{Eighth Region in Which Piston Speed is Equal to or Higher than Fourth Predetermined value}

In the eighth region of the compression stroke, the oil fluid L from the second chamber 20 flows from the second passage 72 into the first chamber 19 by opening the second damping valve 76 in the piston assembly 17. Therefore, in the eighth region of the compression stroke, a damping force having valve characteristics due to the second damping valve 76 is generated.

“Extension stroke in which piston rod 21B is in fourth predetermined range”

In this extension stroke, the piston assembly 17 operates in the same manner as in the third predetermined range. In addition, the second valve assembly 151B moves to the rod guide 23B side in an axial direction of the tube 3 to cause the first fitting member 153B and the second fitting member 233 to be fitted into the sleeve 102B. Then, the first fitting member 153B and the second fitting member 233 close the axial passage 196B at the beginning thereof.

With the axial passage 196B closed in this way, the second valve assembly 151B moves to the rod guide 23B side. Then, the oil fluid L flows from the third chamber 241 to the fourth chamber 242 through the plurality of grooves 116B provided in the sleeve 102B. At that time, as the second valve assembly 151B approaches the rod guide 23B, among the plurality of grooves 116B, the number of the grooves 116B through which the oil fluid L flows from the third chamber 241 to the fourth chamber 242 decreases, and finally becomes zero. Thereby, a damping force of the second valve assembly 151B increases in stages, and a resistance force to movement of the piston rod 21B in an extension direction increases in stages. Here, a length of a press-fitting axis between the small diameter part 231 of the rod guide 23B and the sleeve 102B is set so that the sleeve 102B does not come off from the small diameter part 231 even when the third chamber 241 reaches a maximum pressure.

Here, when the second valve assembly 151B moves to the rod guide 23B side, the third damping valve 154B opens depending on the piston speed. Then, the oil liquid L flows from the third chamber 241 to the fourth chamber 242 via the third passage 191B. Thereby, an excessive increase in pressure in the third chamber 241 is suppressed.

“Compression stroke in which piston rod is in fourth predetermined range”

In this compression stroke, the piston assembly 17 operates in the same manner as in the third predetermined range. In addition, the second valve assembly 151B moves to a side opposite to the rod guide 23B. Then, the first fitting member 153B and the second fitting member 233 open the axial passage 196B and the passages in the plurality of groove parts 182B at the beginning thereof.

With the axial passage 196B and the passages in the plurality of groove parts 182B opened in this way, the second valve assembly 151B moves to a side opposite to the rod guide 23B. Then, the oil fluid L flows from the fourth chamber 242 to the third chamber 241 through the axial passage 196B and the passages in the plurality of groove parts 182B. When the first fitting member 153B of the second valve assembly 151B passes a position of the grooves 116B provided in the sleeve 102B from a state in which it is on the rod guide 23B side with respect to all the grooves 116B provided in the sleeve 102B, the oil fluid L flows from the fourth chamber 242 to the third chamber 241 through the grooves 116B. At that time, as the second valve assembly 151B becomes further away from the rod guide 23B, among the plurality of grooves 116B, the number of grooves 116B through which the oil fluid L flows from the fourth chamber 242 to the third chamber 241 increases. In other words, as the second valve assembly 151B becomes further away from the rod guide 23B, the damping force becomes lower, and a resistance force to the movement of the piston rod 21B in the compression direction becomes lower.

The shock absorber 1B includes the tube 3, the piston rod 21B disposed in the tube 3, the piston 18, the first damping valve 75, and the second damping valve 76 disposed on the piston rod 21B, the valve base 152B and the third damping valve 154B disposed on the piston rod 21B, and the sleeve 102B that can accommodate the valve base 152B. The valve base 152B is constituted by combining the first base member 161B and the second base member 162B. The first base member 161B has the communication passage 178B inside. The first base member 161B includes the valve seat 177B, on which the third damping valve 154B is placed, formed on the lower end surface 161Ba facing the piston 18. In the second base member 162B, the communication passage 178B and the communication passage 186B that communicates with the inside of the sleeve 102B are formed. The disposition groove 195B accommodating the first fitting member 153B and the second fitting member 233 is provided on an outer circumferential side of at least one of the first base member 161B and the second base member 162B, and on a side of the upper end surface 161Bb and the lower end surface 162Bb at which the first base member 161B and the second base member 162B are in contact with each other.

In the extension stroke of the shock absorber 1B, the valve base 152B, the first fitting member 153B, and the second fitting member 233 enter the sleeve 102B. Then, the first fitting member 153B and the second fitting member 233 move with respect to the valve base 152B due to the frictional force with the sleeve 102B to close the axial passage 196B between themselves and the valve base 152B, and thereby a damping force is generated. In the shock absorber 1B, when the third damping valve 154B is provided in the valve base 152B, if a hydraulic pressure in the third chamber 241 becomes higher than a predetermined pressure during the extension stroke, the third damping valve 154B opens to relieve the hydraulic pressure in the third chamber 241 to the fourth chamber 242 via the communication passages 178B and 186B. Thereby, the shock absorber 1B can suppress an excessive increase in hydraulic pressure during the extension stroke in which the valve base 152B enters the sleeve 102B to generate a damping force. Also, during the compression stroke in the shock absorber 1B, the first fitting member 153B and the second fitting member 233 accommodated in the disposition groove 195B of the valve base 152B move with respect to the valve base 152B due to the frictional force with the sleeve 102B to open the axial passage 196B between themselves and the valve base 152B, and thereby the oil fluid L is allowed to flow smoothly from the fourth chamber 242 to the third chamber 241. Thereby, in the shock absorber 1B, movement of the valve base 152B, the first fitting member 153B, and the second fitting member 233 in the sleeve 102B is made smooth during the compression stroke.

In the shock absorber 1B, the valve base 152B, the fitting member 153B, the second fitting member 233, and the third damping valve 154B, which increase the damping force in the vicinity of the extension-side movement end position of the piston rod 21B as described above, can be put together into a compact configuration.

The first fitting member 153B of the shock absorber 1B is made of brass or glass fiber reinforced plastic.

In the shock absorber 1B, the sleeve 102B has the enlarged diameter part 112B on a side into which the second base member 162B is inserted. Thereby, the shock absorber 1B can smoothly increase the damping force when increasing the damping force at the vicinity of the expression-side movement end position of the piston rod 21B.

In the shock absorber 1B of the third embodiment, the same change made for the sleeve 102 into the sleeve 102A may be applied to the sleeve 102B.

### INDUSTRIAL APPLICABILITY

According to the shock absorber according to the above-described aspects of the present disclosure, an increase in cost can be suppressed.

### REFERENCE SIGNS LIST

1, 1A, 1B Shock absorber
3 Tube (first tube)
6 Inner chamber
17 Piston assembly
18 Piston (primary piston)
19 First chamber
20 Second chamber
21, 21B Piston rod
31 First valve assembly
75 First damping valve (first valve)
76 Second damping valve (first valve)
101, 101A Cup
102, 102A, 102B Sleeve (second tube)
103 Base adapter
112, 112B Enlarged diameter part
116, 116A Groove
122 Press-fitting part
123 Leg part
135 Inner circumferential portion
141 Third chamber
142 Communication passage
151 Second valve assembly
152, 152B Valve base (second piston member)
153 Fitting member (ring)
153B First fitting member (ring)
154, 154B Third damping valve (second valve)
161, 161B First base member (first piston member)
161a Upper end surface (one end surface)
161b Lower end surface (contact surface)
161Ba Lower end surface (one end surface)
161Bb Upper end surface (contact surface)
162, 162B Second base member (second piston member)
162a Upper end surface (contact surface)
162Bb Lower end surface (contact surface)
177, 177B Valve seat (seat)
178, 178B Communication passage (first communication passage)
186, 186B Communication passage (second communication passage)
195, 195B Disposition groove
233 Second fitting member (ring)

1.-4. (canceled)

5. A shock absorber comprising:
a first tube;
a piston rod disposed in the first tube;
a primary piston and a first valve disposed on the piston rod;
a secondary piston and a second valve disposed on the piston rod; and
a second tube configured so as to be able to accommodate the secondary piston, wherein
the secondary piston is constituted by combining a first piston member and a second piston member,
the first piston member has a first communication passage inside or on an inner circumferential surface side and includes a seat, on which the second valve is placed, formed on one end surface facing the primary piston,
the second piston member includes a second communication passage formed to communicate with the first communication passage and the inside of the second tube, and
a ring accommodating groove accommodating a ring is provided on an outer circumferential side of at least one of the first piston member and the second piston member, and on a contact surface side at which the first piston member and the second piston member are in contact with each other.

6. The shock absorber according to claim 5, wherein the ring is made of brass or glass fiber-reinforced plastic.

7. The shock absorber according to claim 6, wherein the second tube has an enlarged diameter part on a side into which the secondary piston is inserted.

8. The shock absorber according to claim 5, wherein the second tube has an enlarged diameter part on a side into which the secondary piston is inserted.
